(19) United States
(12) Patent Application Publication
(10) Pub. No.: US 2014/0060486 A1
(43) Pub. Date: Mar. 6, 2014

(54) ENGINE CONTROL SYSTEM

(71) Applicant: SUZUKI MOTOR CORPORATION, Shizuoka (JP)

(72) Inventor: Shingo MAEZAWA, Shizuoka (JP)

(73) Assignee: SUZUKI MOTOR CORPORATION, Shizouka (JP)

(21) Appl. No.: 13/961,436

(22) Filed: Aug. 7, 2013

(30) Foreign Application Priority Data
Sep. 3, 2012 (JP) 2012-193002

(51) Int. Cl. F02D 45/00

(52) U.S. Cl. CPC F02D 45/00
USPC 123/350

(57) ABSTRACT

In a system, a signal output module produces pulses based on rotation of a crankshaft, and outputs a signal having the pulses. A pattern of the pulses shows at least one reference portion of the crankshaft to which the position of at least one cylinder is relative. A reference portion detector performs a reference portion detecting task that detects, based on the pulse pattern of the signal while a rotational direction of the crankshaft is a predetermined direction, the at least one reference portion of the crankshaft. A reverse rotation predicting module predicts whether rotation of the crankshaft in the predetermined direction will be reversed. A disabling module disables the reference portion detector from performing the reference portion detecting task if the reverse rotation predicting module predicts that rotation of the crankshaft in the predetermined direction will be reversed.

### CROSS REFERENCE TO RELATED APPLICATIONS

This application is based on and claims the benefit of priority from Japanese Patent Application No. 2012-193002, filed on Sep. 3, 2012, the disclosure of which is incorporated in its entirety by reference.

### TECHNICAL FIELD

The present invention relates to technologies for measuring the rotational position of a crankshaft of an internal combustion engine, referred to as an engine, and for controlling the engine based on the measured rotational position of the crankshaft.

### BACKGROUND

An engine installed in vehicles is normally equipped with cylinders in which the mixture of air and injected fuel, which is compressed by the piston reciprocating according to rotation of a crankshaft of the engine, is ignited so that combustion takes place therein. In order to properly control when fuel is injected into each cylinder, and when the air-fuel mixture is ignited in each cylinder, an engine control system needs to identify the position of each cylinder, i.e. the position of the piston in each cylinder, with respect to compression TDC (Top Dead Center).

As disclosed in Japanese Patent Publication No. 4521661, how to identify the position of each cylinder is based on a crank angle signal indicative of the rotational position of the crankshaft, obtained by a crank angle sensor, and a cam angle signal indicative of the rotational position of a camshaft. Specifically, the piston position in each cylinder is expressed as a corresponding rotational angle, i.e. a crank-angle (CA) degrees, of the crankshaft.

Execution of each four-stroke combustion cycle of the engine requires two complete revolutions of the crankshaft, so that a rotational angle of the crankshaft is within the range between 0° CA and 720° CA inclusively.

In the Patent Publication No. 4521661, the crank angle sensor is comprised of a discoid encoder member mounted coaxially on the crankshaft that rotates with rotation of the crankshaft.

The encoder member has a number of equidistant teeth distributed around the periphery thereof with missing teeth, i.e. tooth-missing regions. The tooth-missing regions of the encoder member mounted on the crankshaft serve as reference portions of the crankshaft to which a position of each cylinder is relative.

The crank angle sensor is operative to produce a pulse each time a tooth of the encoder member passes through a predetermined position with rotation of the crankshaft, so that the produced pulses constitute a crank angle signal as the output of the crank angle sensor. Each tooth-missing region causes an irregular pulse interval longer than regular pulse intervals in the crank angle signal. An engine control system can detect the position of each cylinder using, for example, the pulse pattern between detected adjacent tooth-missing regions, i.e. between detected irregular pulse intervals, in the crank angle signal. In addition, the engine control system can determine whether there is an abnormality in the crank angle signal based on the pulse pattern between detected adjacent tooth-missing regions in the crank angle signal.

Let us consider how the crankshaft turns after fuel cut of the engine. Specifically, after fuel cut of the engine, reduction in rotating torque being applied to the crankshaft causes the piston in a cylinder not to pass compression TDC, resulting in reverse rotation of the crankshaft, i.e. in swing-back of the crankshaft. During reverse rotation of the crankshaft set forth above, a normal crank angle sensor, which cannot detect reverse rotation of the crankshaft as distinguished from forward rotation thereof, detects rotational positions of the crankshaft different from actual rotational positions thereof. This may cause an engine control system to specify the positions of the respective cylinders based on the detected rotational positions of the crankshaft different from the actual rotational positions thereof. This may result in fuel injection and/or ignition being performed in improper cylinders at the restart of the engine.

Vehicles, typically as idle reduction vehicles, which are controlled to repeatedly perform automatic stop and restart of their engines, have been becoming common these days. Such a vehicle is expected to restart the engine during reverse rotation of the crankshaft. Under the assumption, in such a vehicle controlled to repeatedly perform automatic stop and restart of its engine, it is necessary to prevent fuel injection and/or ignition being performed in improper cylinders at the restart of the engine during reverse rotation of the crankshaft.

In view of these circumstances, there is known a technology disclosed in Japanese Patent Application Publication No. 2007-064161.

The known technology is configured to reset the cylinder identification task at the point of time when rotation of the crankshaft is completely stopped, i.e. the engine is completely stopped, or a starter motor is activated to start a task of restarting the engine. After the reset of the cylinder identification task, the known technology is configured to retry the cylinder identification task. The known technology aims to prevent fuel injection and/or ignition from being performed in improper cylinders at the restart of the engine.

In such an idle reduction vehicle controlled to repeatedly perform automatic stop and restart of its engine, shorter time required to restart the engine is needed. However, resetting the cylinder identification task each time of starting the engine restarting task as disclosed in the Patent Publication No. 2007-064161 may result in difficulty to reduce the time required to restart the engine.

In contrast, a proper update of the rotational position of the crankshaft during reverse rotation of the engine eliminates resetting the cylinder identification task, resulting in shorter time required to restart the engine.

For example, Japanese Patent Application Publication No. 2005-233622 discloses a rotational angle sensor with a function of detecting reverse rotation of the crankshaft. The rotational angle sensor disclosed in the Patent Publication No. 2005-233622 produces a pulse each time a tooth of an encoder member passes through a predetermined position with rotation of the crankshaft; the width of a produced pulse during forward rotation of the crankshaft is different from that of a produced pulse during reverse rotation of the crankshaft. Using such a rotational angle sensor with a function of detecting reverse rotation of the crankshaft permits a proper update of the rotational position of the crankshaft independently of the rotational direction of the crankshaft. This results in elimination of the difference from the detected rotational positions of the crankshaft and corresponding actual rotational positions thereof, thus eliminating the need to reset the task to specify where the piston in each cylinder is positioned therein.

### SUMMARY

Reverse rotation of the crankshaft may cause an engine control system to erroneously detect a tooth-missing region, i.e. a reference portion of the crankshaft to which a position of each cylinder is relative. Let us describe a case where the engine control system erroneously detects tooth-missing regions using FIG. 19.

Referring to FIG. 19, the crank angle sensor produces a pulse each time a tooth of an encoder member passes through a predetermined position with rotation of the crankshaft, and sends the produced pulses to the engine control system as a crank angle signal. The engine control system detects irregular pulse intervals in the crank angle signal sent from the crank angle sensor, thus detecting tooth-missing regions.

As illustrated in FIG. 19, temporary stop of rotation of the crankshaft each time the rotational direction of the crankshaft is changed between the forward direction and the reverse direction may cause a longer interval between adjacent pulses of the crank angle signal, i.e. a longer period during which no pulses are detected. Thus, the engine control system may erroneously detect such a longer interval between adjacent pulses of the crank angle signal due to temporary stop of rotation of the crankshaft as an irregular pulse interval in the crank angle signal, thus erroneously detecting a tooth-missing region (see time T11 or time T12).

The engine control module normally carries out how to determine whether there is an abnormality in the crank signal using detected tooth-missing regions.

Specifically, the engine control system matches the pulse pattern between detected adjacent tooth-missing regions in the crank angle signal with a normal pulse pattern therebetween. Then, the engine control system determines that there is an abnormality in the crank angle signal upon the pulse pattern between detected adjacent tooth-missing regions in the crank angle signal being mismatched with the normal pulse pattern therebetween.

Thus, erroneously detected tooth-missing regions may cause the engine control system to mistakenly determine whether there is an abnormality in the crank angle signal.

As disclosed in the Patent Publication No. 4521661, an engine control system detects the piston position in each cylinder using the pulse pattern between detected adjacent tooth-missing regions in the crank angle signal. Thus, erroneously detected tooth-missing regions may cause the engine control system to mistakenly identify the position of each cylinder, resulting in fuel injection and/or ignition being performed in improper cylinders. If the engine control system updates the rotational position of the crankshaft using the identified position of each cylinder, erroneously detected tooth-missing regions may cause the engine control system to erroneously update the rotational position of the crankshaft.

In view of the circumstances set forth above, one aspect of the present invention seeks to provide engine control systems designed to address the problems set forth above.

Specifically, an alternative aspect of the present invention aims to provide such engine control systems, each of which is capable of preventing erroneous detection of at least one reference portion of a crankshaft to which a position of at least one cylinder is relative due to reverse rotation of the crankshaft or another cause.

According to an aspect of the present invention, there is provided a system for controlling an engine having at least one cylinder and a crankshaft. The system includes a signal output module configured to produce pulses based on rotation of the crankshaft, and output a signal having the pulses. A pattern of the pulses showing at least one reference portion of the crankshaft to which a position of the at least one cylinder is relative. The system includes a reference portion detector configured to perform a reference portion detecting task that detects, based on the pattern of the pulses of the signal while a rotational direction of the crankshaft is a predetermined direction, the at least one reference portion of the crankshaft. The system includes a reverse rotation predicting module configured to predict whether rotation of the crankshaft in the predetermined direction will be reversed. The system includes a disabling module configured to disable the reference portion detector from performing the reference portion detecting task if the reverse rotation predicting module predicts that rotation of the crankshaft in the predetermined direction will be reversed.

The system according to a first exemplary embodiment of the aspect further includes an abnormality determiner configured to perform an abnormality determining task that determines whether there is an abnormality in the pattern of the pulses of the signal based on the at least one reference portion of the crankshaft. The disabling module is configured to disable the abnormality determiner from performing the abnormality determining task if the reverse rotation predicting module predicts that rotation of the crankshaft in the predetermined direction will be reversed.

In the system according to a second exemplary embodiment of the aspect, the reverse rotation predicting module is configured to predict that rotation of the crankshaft in the predetermined direction will be reversed during a period from an occurrence of a request to stop the engine to complete stop of rotation of the crankshaft of the engine.

The system according to a third exemplary embodiment of the aspect further includes an engine start detector configured to detect that the engine is started, and an enabling module configured to enable the reference portion detector to perform the reference portion detecting task if the engine start detector is configured to detect that the engine is started.

The system according to an example of the first exemplary embodiment further includes an engine start detector configured to detect that the engine is started, and an enabling module configured to enable the abnormality determiner to perform the abnormality determining task if the engine start detector is configured to detect that the engine is started.

In an example of the second exemplary embodiment, the request to stop the engine is one of a request to start idle reduction of the engine and a request to stop the engine in response to turn-off of an ignition switch.

In a fourth exemplary embodiment of the aspect, the position of the at least one cylinder is changed based on rotation of the crankshaft. The system further includes a cylinder-position identifying module configured to perform a cylinder-position identifying module that identifies the position of the at least one cylinder based on the signal output from the signal output module. The disabling module is configured to disable the cylinder-position identifying module to perform the cylinder-position identifying task if the reverse rotation predicting module predicts that rotation of the crankshaft in the predetermined direction will be reversed.

In an example of the fourth exemplary embodiment, the reverse rotation predicting module is configured to predict that rotation of the crankshaft in the predetermined direction will be reversed during a period from an occurrence of a request to stop the engine to complete stop of rotation of the crankshaft of the engine. The system further includes an engine start detector configured to detect that the engine is started. The system includes an enabling module configured to enable the cylinder-position identifying module to perform the cylinder-position identifying task if the engine start detector is configured to detect that the engine is started.

The system according to the example of the fourth exemplary embodiment further includes a rotational position updating module configured to update a rotational position of the crankshaft based on the signal output from the signal output module. The cylinder-position identifying module is configured to identify, in the cylinder-position identifying task enabled by the enabling module, the position of the at least one cylinder based on the rotational position of the crankshaft updated by the rotational position updating module while the reverse rotation predicting module predicts that rotation of the crankshaft in the predetermined direction will be reversed.

In the system according to a fifth exemplary embodiment of the aspect, the engine has a camshaft that rotates based on rotation of the crankshaft. The system further includes a cam-signal output module configured to produce pulses based on rotation of the camshaft, and output a cam-signal having the pulses, and an abnormality determiner configured to perform an abnormality determining task that determines whether there is an abnormality in a pattern of the pulses of the cam-signal based on the reference portion of the crankshaft. The disabling module is configured to disable the abnormality determiner from performing the abnormality determining task if the reverse rotation predicting module predicts that rotation of the crankshaft in the predetermined direction will be reversed.

In the fifth exemplary embodiment, the reverse rotation predicting module is configured to predict that rotation of the crankshaft in the predetermined direction will be reversed during a period from an occurrence of a request to stop the engine to complete stop of rotation of the crankshaft of the engine. The system further includes an engine start detector configured to detect that the engine is started, and an enabling module configured to enable the abnormality determiner to perform the abnormality determining task if the engine start detector is configured to detect that the engine is started.

In the system according to a sixth exemplary embodiment of the aspect, the signal output module includes an encoder member. The encoder member includes a reluctor disc mounted coaxially on the crankshaft, a signal generator portion having a number of equidistant teeth distributed around a periphery of the reluctor disc, and first and second tooth-missing portions each being a predetermined region on the periphery of the reluctor disc in which a predetermined number of teeth are missed. The first and second tooth-missing portions serve as the at least one reference portion of the crankshaft. The signal output module is configure to produce a pulse of the signal each time a tooth of the signal generator portion passes through a predetermined position with a given angle of rotation of the crankshaft. Each of the first and second tooth-missing portions causes an irregular pulse interval in the signal. The reference portion detector is configured to perform the reference portion detecting task that detects, based on the irregular pulse intervals in the signal while the rotational direction of the crankshaft is the predetermined direction, the respective first and second tooth-missing portions.

In the aspect of the present invention, disabling execution of the reference portion detecting task if it is predicted that rotation of the crankshaft in the predetermined direction will be reversed prevents erroneous detection of the at least one reference portion of the crankshaft due to reverse rotation of the crankshaft.

In the first exemplary embodiment, disabling execution of the abnormality determining task if it is predicted that rotation of the crankshaft in the predetermined direction will be reversed prevents wrong determination that there is an abnormality in the pattern of the pulses of the signal due to reverse rotation of the crankshaft.

In the second exemplary embodiment, detection of the occurrence of the request to stop the engine makes it possible to simply predict that the rotation of the crankshaft in the predetermined direction will be reversed.

In the third exemplary embodiment, it is possible to smoothly perform, without delay, the reference portion detecting task when the engine is started.

In the example of the first exemplary embodiment, it is possible to smoothly perform, without delay, the abnormality determining task when the engine is started.

In the example of the second exemplary embodiment, detection of either the request to start idle reduction of the engine or the request to stop the engine in response to turn-off of the ignition switch makes it possible to simply predict that rotation of the crankshaft in the predetermined direction will be reversed.

In the fourth exemplary embodiment, disabling execution of the cylinder-position identifying task if it is predicted that rotation of the crankshaft in the predetermined direction will be reversed prevents wrong identification of the position of the at least one cylinder due to reverse rotation of the crankshaft.

In the example of the fourth exemplary embodiment, it is possible to smoothly perform, without delay, the cylinder-position identifying task when the engine is started.

Particularly, in the example of the fourth exemplary embodiment, the rotational position of the crankshaft is updated based on the signal output from the signal output module even if the cylinder-position identifying task is disabled for a period during which it is predicted that rotation of the crankshaft in the predetermined direction will be reversed. Thereafter, in the cylinder-position identifying task enabled by the enabling module, it is possible to identify the position of the at least one cylinder based on the last updated rotational position of the crankshaft for the period during which it is predicted that rotation of the crankshaft in the predetermined direction will be reversed. Thus, even if the cylinder-position identifying task is disabled for the period during which it is predicted that rotation of the crankshaft in the predetermined direction will be reversed, it is possible to identify the position of the at least one cylinder immediately after the lapse of the period during which it is predicted that rotation of the crankshaft in the predetermined direction will be reversed. This results in rapid restart of the engine based on the identified position of the at least one cylinder.

In the fifth exemplary embodiment, disabling execution of the abnormality determining task if it is predicted that rotation of the crankshaft in the predetermined direction will be reversed prevents wrong identification of the position of the at least one cylinder due to reverse rotation of the crankshaft.

Specifically, in the fifth exemplary embodiment, it is possible to smoothly perform, without delay, the abnormality determining task when the engine is started.

### BRIEF DESCRIPTION OF THE DRAWINGS

Other aspects of the present invention will become apparent from the following description of embodiments with reference to the accompanying drawings in which:

FIG. 1 is a block diagram schematically illustrating a structural example of an engine control system according to a first embodiment of the present invention; and

FIGS. 2A to 2C jointly illustrate a timing chart schematically illustrating an example of a crank angle signal and that of a cam angle signal output from respective crank angle sensor and cam angle sensor illustrated in FIG. 1 while these sensors are normally operating;

FIG. 3 is a flowchart schematically illustrating an example of specific operations of an idle-reduction mode determining task carried out by an ECU illustrated in FIG. 1;

FIG. 4 is a flowchart schematically illustrating an example of specific operations of a first abnormality determining task carried out by the ECU illustrated in FIG. 1;

FIG. 5 is a flowchart schematically illustrating an example of specific operations of a second abnormality determining task carried out by the ECU illustrated in FIG. 1;

FIG. 6 is a flowchart schematically illustrating an example of specific operations of a crank-angle position reviewing task carried out by the ECU illustrated in FIG. 1;

FIG. 7 is a table in which first to fourth requirements for cylinder identification according to the first embodiment are stored;

FIG. 8 is a timing chart schematically illustrating an example of a pulse pattern of a crank signal according to the first embodiment when the crank angle sensor normally operates;

FIG. 9 is a timing chart schematically illustrating an example of a pulse pattern of the cam signal according to the first embodiment when the cam angle sensor normally operates;

FIG. 10 is a view schematically illustrating how engine rotation varies after an idle-reduction mode is established according to the first embodiment;

FIG. 11 is a timing chart schematically illustrating a first case where erroneously detected tooth-missing regions result in the pulse pattern of the crank angle signal or that of the cam angle signal being mistakenly determined to be abnormal;

FIG. 12 is a timing chart schematically illustrating a second case where erroneously detected tooth-missing regions cause an identified position of a corresponding cylinder to be mistakenly reviewed;

FIG. 13 is a flowchart schematically illustrating an example of specific operations of an idle-reduction mode determining task carried out by an ECU illustrated in FIG. 1 according to a modification of the first embodiment;

FIG. 14 is a block diagram schematically illustrating a structural example of an engine control system according to a second embodiment of the present invention;

FIG. 15 is a flowchart schematically illustrating an example of specific operations of an engine stop-mode determining task carried out by the ECU illustrated in FIG. 14;

FIG. 16 is a view schematically illustrating how engine rotation varies after the engine stop mode is established according to the second embodiment;

FIG. 17 is a flowchart schematically illustrating an example of specific operations of an engine stop-mode determining task carried out by an ECU illustrated in FIG. 14 according to a modification of the second embodiment;

FIG. 18 is a flowchart schematically illustrating an example of specific operations of another example of a task to update the rotational position of the crankshaft; and

FIG. 19 is a view schematically illustrating a case where an engine control system mistakenly determines tooth-missing regions.

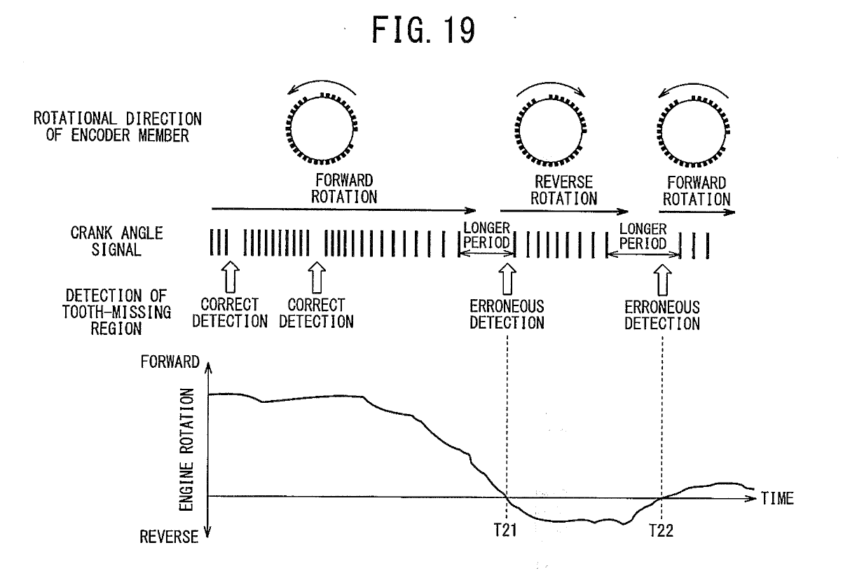

### DETAILED DESCRIPTION OF EMBODIMENT

Embodiments of the present invention will be described hereinafter with reference to the accompanying drawings.

### First Embodiment

Let us describe an engine control system according to a first embodiment hereinafter.

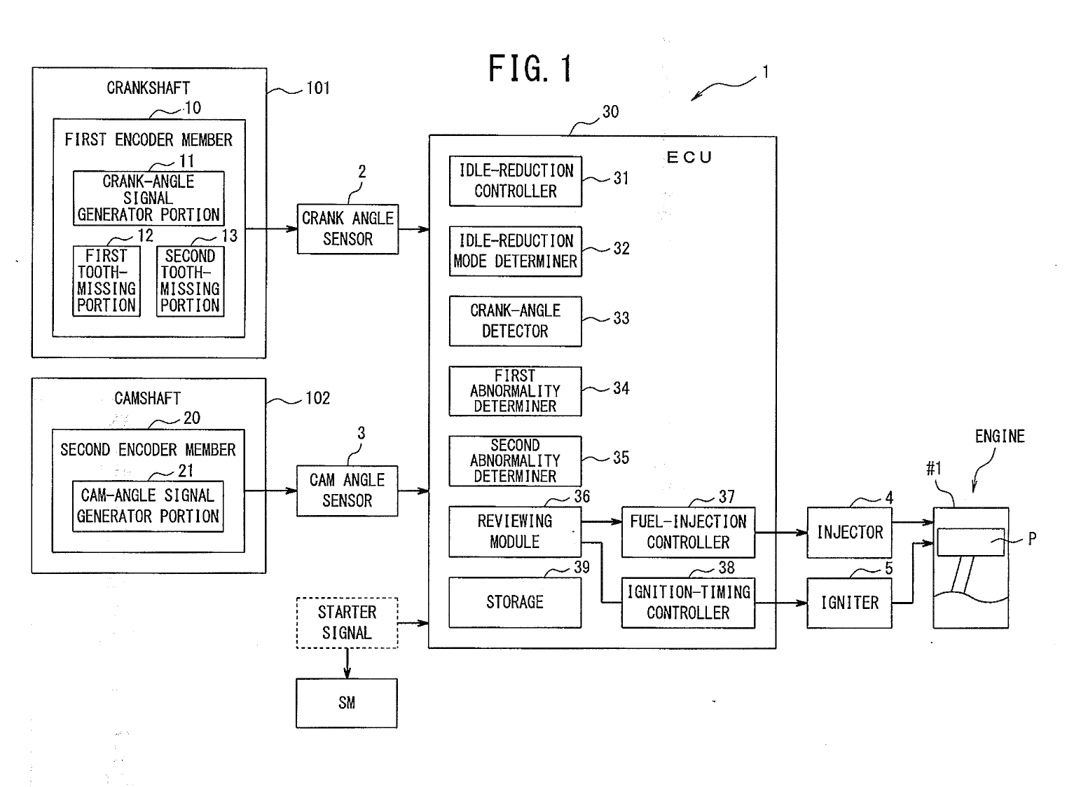

FIG. 1 schematically illustrates a structural example of an engine control system 1.

The engine control system 1 is operative to control an engine installed in a vehicle. For example, in the first embodiment, a three-cylinder internal combustion engine is used as a controlled object of the engine control system 1. Identical numbers, i.e. cylinder numbers, #1, #2, and #3 are assigned to the respective three cylinders, and, in FIG. 1, the cylinder #1 is only illustrated to avoid complexity.

The engine has a crankshaft 101 coupled to a piston via a connection rod within each cylinder such that reciprocate travel of the piston in each cylinder allows the crankshaft 101 to be turned. The engine also has a camshaft 102 coupled to the crankshaft 101. For example, the camshaft 102 turns once every time the crankshaft 101 turns two times.

Specifically, the engine works to compress air-fuel mixture within each cylinder by the piston and burn the compressed air-fuel mixture within each cylinder. This changes the fuel energy to mechanical energy, such as rotational energy, to reciprocate the piston within each cylinder, thus rotating the crankshaft 101. The rotation of the crankshaft 101 is transferred through a transmission (not shown) and the like to a driving shaft (not shown) to which driving wheels (not shown) are attached, thus driving the vehicle.

Referring to FIG. 1, the engine control system 1 includes a first encoder member 10, a second encoder member 20, a crank angle sensor 2, a cam angle sensor 3, an ECU (Electronic Control Unit) 30, fuel injectors 4 provided for the respective cylinders, and ignites 5 including voltage boosters provided for the respective cylinders.

The first encoder member 10 is comprised of a reluctor disc mounted coaxially on the crankshaft 101 as to be rotatable with rotation of the crankshaft 101. The first encoder member 10 is comprised of a crank-angle signal generator portion 11, a first tooth-missing portion 12, and a second tooth-missing portion 13. The crank-angle signal generator portion 11 has a number of equidistant teeth distributed around the periphery of the reluctor disc. The first tooth-missing portion 12 is a predetermined region on the periphery of the reluctor disc in which a predetermined number of teeth are missed. The second tooth-missing portion 13 is a predetermined region on the periphery of the reluctor disc in which a predetermined number of teeth are missed.

The crank angle sensor 2 is operative to produce a pulse each time a tooth of the crank-angle signal generator portion 11 passes through a predetermined position with a predetermined crank unit angle of rotation of the crankshaft 101, so that the produced pulses constitute a crank angle signal as the output of the crank angle sensor 2. Each of the first and second tooth-missing portions 12 and 13 causes an irregular pulse interval in the crank angle signal. The first encoder member 10 and the crank angle sensor 2 serve as a crank angle sensor device.

The second encoder member 20 is comprised of a reluctor disc mounted coaxially on the camshaft 102 as to be rotatable with rotation of the camshaft 102. The second encoder member 20 is comprised of a cam-angle signal trigger portion 21. The cam-angle signal trigger portion 21 has a number of teeth distributed around the periphery of the reluctor disc.

The cam angle sensor 3 is operative to produce a pulse each time a tooth of the cam-angle signal trigger portion 21 passes through a predetermined position with a predetermined angle of rotation of the camshaft 102, so that the produced pulses constitute a cam angle signal as the output of the cam angle sensor 3. The second encoder member 20 and the cam angle sensor 3 serve as a cam angle sensor device.

As described above, the crank angle sensor 2 is operative to produce a pulse each time a tooth of the crank-angle signal trigger portion 11 passes through a predetermined position with a predetermined angle of rotation of the crankshaft 101, so that the produced pulses constitute the crank angle signal as the output of the crank angle sensor 2. In addition, the crank angle sensor 2 is operative to produce a pulse each time a tooth of the crank-angle signal trigger portion 11 passes through the predetermined position such that the width of a produced pulse during forward rotation of the crankshaft 101 is different from that of a produced pulse during reverse rotation of the crankshaft 101. The crank angle sensor 2 is operative to output the crank angle signal to the ECU 30.

As described above, the cam angle sensor 3 is operative to produce a pulse each time a tooth of the cam-angle signal trigger portion 21 passes through the predetermined position with a predetermined angle of rotation of the camshaft 102, so that the produced pulses constitute the cam angle signal as the output of the cam angle sensor 3. The cam angle sensor 3 is operative to output the cam angle signal to the ECU 30.

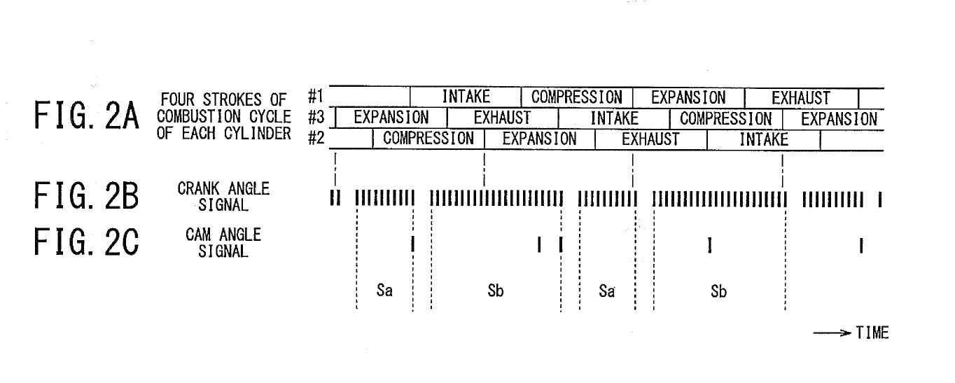

FIG. 2 schematically illustrates an example of the crank angle signal and that of the cam angle signal output from the respective crank angle sensor 2 and cam angle sensor 3 while these sensors 2 and 3 are normally operating. FIG. 2A schematically illustrates the four strokes, which includes Intake stroke, Compression stroke, Power stroke (Expansion stroke), and Exhaust stroke, of a four-stroke combustion cycle of each of the cylinders #1, #2, and #3. FIG. 2B illustrates the pulses of the crank angle signal produced by the crank angle sensor 2 while the crankshaft 101 turns in one direction. FIG. 2C illustrates the pulses of the cam angle signal produced by the cam angle sensor 3 while the camshaft 102 turns in one direction. Specifically, FIGS. 2A to 2C illustrate an example of the relationship between the four strokes of the four-stroke combustion cycle of each of the cylinders, the crank angle signal, and the cam angle signal.

Specifically, one complete four-stroke cycle of each cylinder requires two complete revolutions of the crankshaft 101, i.e. reciprocating motions, of the piston P. In the cylinder #1 as an example, the intake stroke, i.e. the downward movement of the piston P, pulls fuel and air into the combustion chamber, and the compression stroke, i.e. the upward movement of the piston P, compresses the air-fuel mixture in the compression chamber. The power stroke, i.e. the downward movement of the piston P, comes about through the expansion of the burning compressed air-fuel mixture due to ignition of the compressed air-fuel mixture. The exhaust stroke, i.e. the upward movement of the piston P, expels the exhaust gas from the cylinder #1.

The crank-angle signal generator portion 11, the first tooth-missing portion 12, and the second tooth-missing portion 12 cause the crank angle sensor 2 to produce a crank angle signal in which a first set of ten equidistant pulses and a second set of twenty-two equidistant pulses alternately occur if the crank angle signal is normal (see FIG. 2B). In addition, the cam-angle signal trigger portion 21 causes the cam angle sensor 3 to produce a can angle signal including a predetermined number of pulses having predetermined intervals therebetween if the cam angle signal is normal (see FIG. 2C).

Specifically, as illustrated in FIG. 2B, the crank angle signal has cyclic sections, i.e. regular-pulse sections, Sa and Sb, each of which occurs between adjacent irregular pulse intervals corresponding to adjacent tooth-missing regions. The number of pulses of the cam angle signal occurring within the regular pulse sections Sa and Sb can be denoted by an expression “pulse pattern (i1, i2, . . . , in)”.

In the first embodiment, the normal pulse pattern of the cam angle signal shown in FIG. 2C would be described as repetition of “specified pulse pattern (1, 2, 0, 1)”. Specifically, within a first regular pulse section Sa of the crank angle signal, there is one pulse of the cam angle signal, and, within a second regular pulse section Sb next to the first regular pulse section Sa, there are two pulses of the cam angle signal. Within a third regular pulse section Sa next to the second regular pulse section Sb, there are no pulses of the cam angle signal, and, within a fourth regular pulse section Sb next to the third regular pulse section Sa, there is one pulse of the cam angle signal. Thereafter, the same pattern is repeated.

The ECU 30 serves as an engine controller. The ECU 30 for example includes a microcomputer and its peripherals. Specifically, the ECU 30 is comprised of a CPU, a ROM, a RAM, and so on.

The ECU 30 is operative to perform various tasks for controlling the engine. Specifically, the ECU 30 functionally includes an idle-reduction controller 31, an idle-reduction mode determiner 32, a crank-angle detector 33, a first abnormality determiner 34, a second abnormality determiner 35, a reviewing module 36, a fuel-injection controller 37, an ignition-timing controller 38, and a storage 39.

The idle-reduction controller 31 performs an idle-reduction task to stop the engine if at least one idle-reduction condition, such as stop of the vehicle, is satisfied. For example, the idle-reduction controller 31 is operative to output an instruction to the fuel-injection controller 37 to instruct the fuel-injection controller 37 to cut fuel supply from the injectors 4 to the respective cylinders #1 to #3. The idle-reduction determiner 32 is operative to determine whether the idle-reduction controller 31 starts the idle-reduction task. The specific operations carried out by the idle-reduction determiner 32 will be described in detail later.

The crank-angle detector 33 detects a current crank angle position, i.e. a current crank-angle (CA) degrees, relative to a reference position for each pulse of the crank angle signal. Specifically, the crank-angle detector 33 counts up each time a pulse of the crank angle signal occurs during forward rotation of the crankshaft 101, thus detecting, based on the count value, the current crank angle position. In addition, the crank-angle detector 33 counts down each time a pulse occurs in the crank angle signal during reverse rotation of the crankshaft 101, thus detecting, based on the count value, the current crank angle position.

Further, the crank-angle detector 33 calculates an engine speed based on the crank angle signal.

The first abnormality determiner 34 is designed to determine whether the pulse pattern of the crank angle signal is abnormal based on the crank angle signal. The first abnormality determiner 34 is also designed to, when an engine automatic stop task in the idle-reduction task is started, predict that reverse rotation of the crankshaft 101 will occur, then disabling the determination of whether the pulse pattern of the crank angle signal is abnormal. The specific operations carried out by the first abnormality determiner 34 will be described in detail later.

The second abnormality determiner 35 is designed to determine whether the pulse pattern of the cam angle signal is abnormal based on the cam angle signal. The second abnormality determiner 35 is also designed to, when an engine automatic stop task in the idle-reduction task is started, predict that reverse rotation of the crankshaft 101 will occur, thus disabling the determination of whether the pulse pattern of the cam angle signal is abnormal. The specific operations carried out by the second abnormality determiner 35 will be described in detail later.

The reviewing module 36 is designed to review a current piston position in each cylinder corresponding to the current crank angle position detected by the crank-angle detector 33 based on the crank angle signal and the cam angle signal. In addition, the reviewing module 36 is designed to, when an engine automatic stop task in the idle-reduction task is started, predict that reverse rotation of the crankshaft 101 will occur, thus disabling execution of the review. The specific operations carried out by the reviewing module 36 will be described in detail later.

The fuel-injection controller 37 is designed to control each of the injectors 4 based on a result of the review by the reviewing module 36 to thereby cause a target injector 4 to spray a controlled quantity of fuel into a corresponding target cylinder at a controlled timing.

The ignition-timing controller 38 is designed to control, using an ignition control signal, a target igniter 5 based on a result of the review by the reviewing module 36, so that the target igniter 5 generates, at a controlled timing, a spark in the target cylinder via a spark plug (not shown) installed in the target cylinder, thus start burning the air-fuel mixture in the combustion chamber of the target cylinder.

In the storage 39, which is constructed by at least one of the ROM and RAM, one or more programs are stored; the one or more programs cause the ECU 30 to perform the various tasks using the storage 39. The ECU 30 also can store obtained data during execution of at least one of the tasks.

Next, an idle-reduction mode determining task, referred to simplay as a determining task, carried out by the idle-reduction determiner 32 will be described hereinafter.

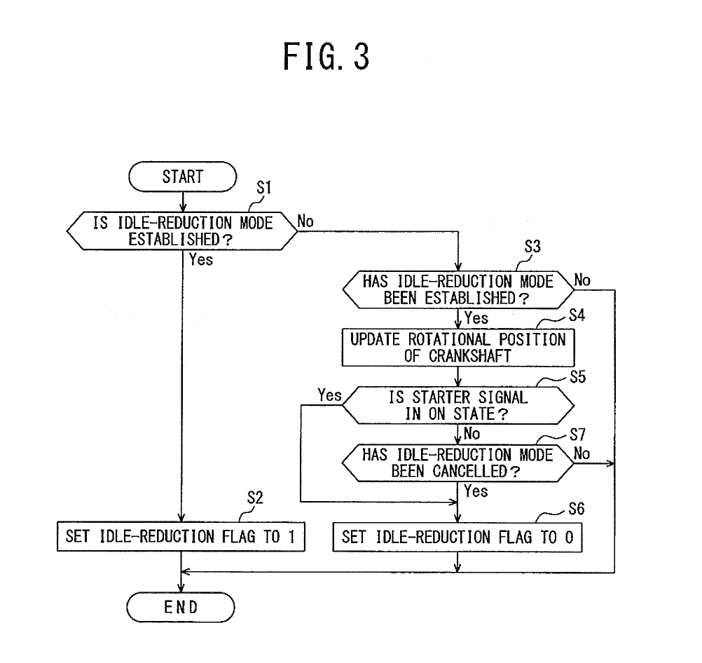

FIG. 3 schematically illustrates an example of specific operations of the determining task carried out by the ECU 30. For example, the idle-reduction determiner 32 performs the determining task every 10 milliseconds [ms].

Referring to FIG. 3, in step S1, the idle-reduction mode determiner 32 determines whether the operation mode of the engine is shifted from a normal mode to an idle-reduction mode, i.e. the idle-reduction mode is established in step S1. Specifically, when the idle-reduction controller 31 starts the idle-reduction task, i.e. outputs an engine stop instruction to the fuel-injection controller 37 to instruct the fuel-injection controller 37 to cut fuel supply, the idle-reduction mode is established.

Upon determination that the idle-reduction mode is established, the idle-reduction mode determiner 32 carries out the operation in step S2. Otherwise, upon determination that the idle-reduction mode is not established, i.e. the idle-reduction task has not been started or the idle-reduction task has been started, the idle-reduction mode determiner 32 carries out the operation in step S3.

In step S2, the idle-reduction mode determiner 32 sets an idle-reduction running flag, which is a bit of 0 or 1, to 1. The idle-reduction running flag indicates whether the idle-reduction mode is established. The value of 1 set to the idle-reduction running flag shows that the idle-reduction mode is established, in other words, the idle-reduction task is being executed, and the value of 0 set to the idle-reduction running flag shows that the idle-reduction mode is not established, in other words, the idle-reduction task is not being executed.

In step S3, the idle-reduction mode determiner 32 determines whether the idle-reduction mode is established, in other words, whether idle-reduction running flag is set to 1.

Upon determination that the idle-reduction mode is established, the idle-reduction mode determiner 32 carries out the operation in step S4. Otherwise, upon determination that the idle-reduction mode is non-established, the idle-reduction mode determiner 32 terminates the determining task illustrated in FIG. 3.

In step S4, the idle-reduction mode determiner 32 updates the rotational position of the crankshaft 101 stored in the storage 39 each time a new one is detected by the crank-angle detector 33.

Next, the idle-reduction mode determiner 32 determines whether a starter signal for driving a starter motor SM is in an on state. The starter motor SM is operative to rotate the crankshaft 101 to crank the engine being stopped in step S5.

Upon determination that the starter signal for driving the starter motor SM is in the on state, the idle-reduction mode determiner 32 carries out the operation in step S6. Otherwise, upon determination that the starter signal for driving the starter motor SM is not in the on state, i.e. is in an off state, the idle-reduction mode determiner 32 carries out the operation in step S7.

In step S7, the idle-reduction mode determiner 32 determines whether the idle-reduction mode is non-established, i.e. whether the idle-reduction controller 31 has terminated the idle-reduction task. Specifically, when the idle-reduction controller 31 has terminated the idle-reduction task, the idle-reduction mode is non-established.

Upon determination that the idle-reduction mode is non-established, the idle-reduction mode determiner 32 carries out the operation in step S6. Otherwise, upon determination that the idle-reduction mode is established, i.e. the idle-reduction task has been performed, the idle-reduction mode determiner 32 terminates the determining task illustrated in FIG. 3.

In step S6, the idle-reduction mode determiner 32 sets the idle-reduction running flag to 0, so that the idle-reduction flag is not established. That is, the value of 0 set to the idle-reduction running flag shows that the idle-reduction mode is not established. Thereafter, the idle-reduction mode determiner 32 terminates the determining task illustrated in FIG. 3.

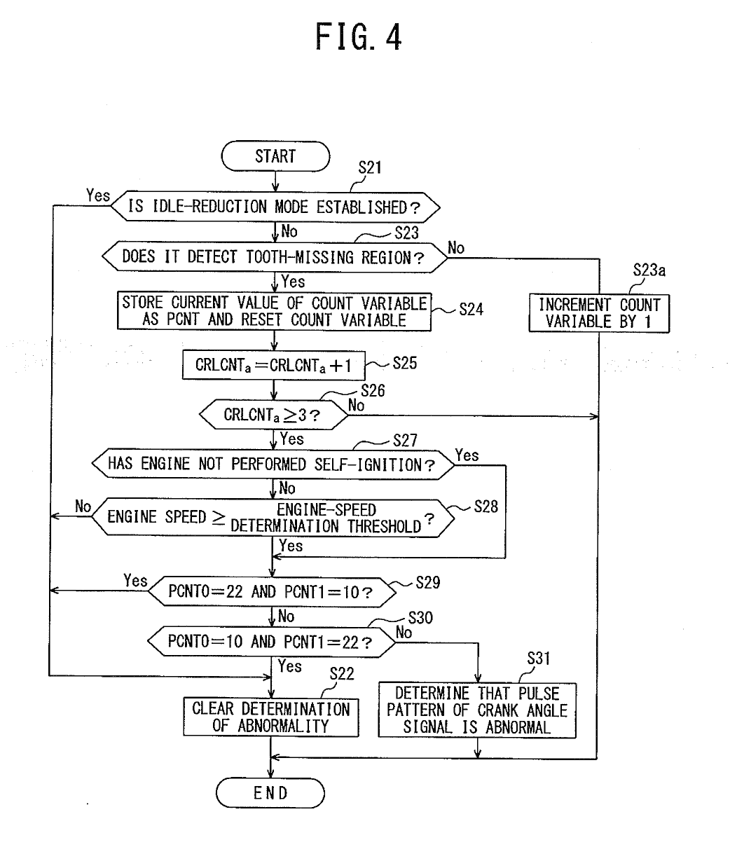

Next, a first abnormality determining task carried out by the first abnormality determiner 34 will be described hereinafter. FIG. 4 schematically illustrates an example of specific operations of the first abnormality determining task carried out by the ECU 30. For example, the first abnormality determiner 34 performs the first abnormality determining task each time a pulse of the crank angle signal is input to the ECU 30.

Referring to FIG. 4, in step S21, the first abnormality determiner 34 determines whether the idle-reduction mode is established, in other words, whether the idle-reduction running flag is set to 1. Upon determination that the idle-reduction mode is established, the first abnormality determiner 34 carries out the operation in step S22. Otherwise, upon determination that the idle-reduction mode is non-established, the first abnormality determiner 34 carries out the operation in step S23.

If the determination of step S21 is affirmative, in step S22, the first abnormality determiner 34 clears, if it was determined that the pulse pattern of the crank angle signal was abnormal in step S31 described later before the current execution of the first abnormality determining task illustrated in FIG. 4, the determined result. If the determination in step S29 or S30 described later is affirmative, the first abnormality determiner 34 clears, if it was determined that the pulse pattern of the crank angle signal was abnormal in step S31 described later before the current execution of the first abnormality determining task illustrated in FIG. 4, the determined result, thus determining that the pulse pattern of the crank angle signal is normal. Thereafter, the first abnormality determiner 34 terminates the first abnormality determining task illustrated in FIG. 4.

In step S23, the first abnormality determiner 34 determines whether to detect an irregular pulse interval corresponding to a tooth-missing region in the crank angle signal.

For example, when the interval between a current detected pulse and the immediately previous detected pulse of the crank angle signal is longer than the regular intervals between the previous detected pulses therein, the first abnormality determiner 34 determines that the interval between the current detected pulse and the immediately previous pulse is detected as an irregular pulse interval corresponding to a tooth-missing region in the crank angle signal. The length of an irregular pulse interval corresponding to a tooth-missing region in the crank angle signal is previously determined experimentally, empirically, and/or theoretically.

Upon determination that no tooth-missing regions are detected, the first abnormality determiner 34 increments, by 1, a count variable indicative of the number of produced pulses of the crank angle signal in step S23a; the initial value of the count variable is set to zero. Thereafter, the first abnormality determiner 34 terminates the first abnormality determining task illustrated in FIG. 4. As a result, the count variable is incremented by 1 each time a produced pulse of the crank angle signal is input to the ECU 30 until it is determined that an irregular pulse interval corresponding to a tooth-missing region is detected in the crank angle signal.

Otherwise, upon determination that a tooth-missing region is detected, the first abnormality determiner 34 carries out the operation in step S24.

In step S24, the first abnormality determiner 34 stores the current value of the count variable in the storage 39 as a pulse-number count value PCNT, and resets the count variable to zero. Then, the first abnormality determiner 34 performs the operation in step S25.

In step S25, the first abnormality determiner 34 increments a tooth-missing count variable CRLCNTa by 1, which is expressed by CRLCNTa=CRLCNTa+1. Note that the tooth-missing count variable CRLCNTa is reset to zero each time the starter signal is turned from the off state to the on state.

Next, in step S26, the first abnormality determiner 34 determines whether the value of the tooth-missing count variable CRLCNTa is equal to or greater than 3.

Note that the first abnormality determiner 34 needs to obtain at least successive two pulse-number count values PCNT in order to perform the operations in steps S29 and S30 described later. The latest one of the at least two successive two pulse-number count values PCNT is represented as PCNT0, and another thereof, which is immediately before the latest one, is represented as PCNT1. Thus, detection of three or more tooth-missing regions, i.e. detection of at least two irregular intervals, in the crank angle signal is needed. For this reason, the first abnormality determiner 34 performs the determination of whether the value of the tooth-missing count variable CRLCNTa is equal to or greater than 3.

Upon determination that the value of the tooth-missing count variable CRLCNTa is less than 3, the first abnormality determiner 34 terminates the first abnormality determining task illustrated in FIG. 4. As a result, the operations in steps S21 to S26 are performed each time a produced pulse of the crank angle signal is input to the ECU 30 until it is determined that the value of the tooth-missing count variable CRLCNTa is equal to or greater than 3. Thus, in the storage 39, at least the pulse-number count value PCNT0 corresponding to the latest tooth-missing region and the pulse-number count value PCNT1 corresponding to the tooth-missing region immediately before the latest tooth-missing region are stored.

Otherwise, upon determination that the value of the tooth-missing count variable CRLCNTa is equal to or greater than 3, the first abnormality determiner 34 carries out the operation in step S27.

In step S27, the first abnormality determiner 34 determines whether the engine has not performed self-ignition, i.e. the engine is cranking by the starter motor SM. Upon determination that the engine has not performed self-ignition, the first abnormality determiner 34 performs the operation in step S29. Otherwise, upon determination that the engine has performed self-ignition, the first abnormality determiner 34 performs the operation in step S28.

In step S28, the first abnormality determiner 34 determines whether the engine speed calculated by the crank-angle detector 33 is equal to or greater than an engine-speed determination threshold. The engine-speed determination threshold is a value of the engine speed while rotation of the crankshaft 101 of the engine is stable. The engine-speed determination threshold is previously determined experimentally, empirically, and/or theoretically.

Upon determination that the engine speed is equal to or greater than the engine-speed determination threshold, the first abnormality determiner 34 carries out the operation in step S29. Otherwise, upon determination that the engine speed is less than the engine-speed determination threshold, the first abnormality determiner 34 carries out the operation in step S22 set forth above.

In step S29, the first abnormality determiner 34 determines whether the pulse-number count value PCNT0 is 22, and the pulse-number count value PCNT1 is 10. Upon determination that the pulse-number count value PCNT0 is 22, and the pulse-number count value PCNT1 is 10, the first abnormality determiner 34 carries out the operation in step S22 set forth above. Otherwise, upon determination that either the pulse-number count value PCNT0 is not 22 or the pulse-number count value PCNT1 is not 10, the first abnormality determiner 34 carries out the operation in step S30.

In step S30, the first abnormality determiner 34 determines whether the pulse-number count value PCNT0 is 10, and the pulse-number count value PCNT1 is 22. Upon determination that the pulse-number count value PCNT0 is 10, and the pulse-number count value PCNT1 is 22, the first abnormality determiner 34 carries out the operation in step S22. Otherwise, upon determination that either the pulse-number count value PCNT0 is not 10, or the pulse-number count value PCNT1 is not 22, the first abnormality determiner 34 carries out the operation in step S31.

In step S31, the first abnormality determiner 34 determines that the pulse pattern of the crank angle signal is abnormal, and thereafter, terminates the first abnormality determining task.

Next, a second abnormality determining task carried out by the second abnormality determiner 35 will be described hereinafter.

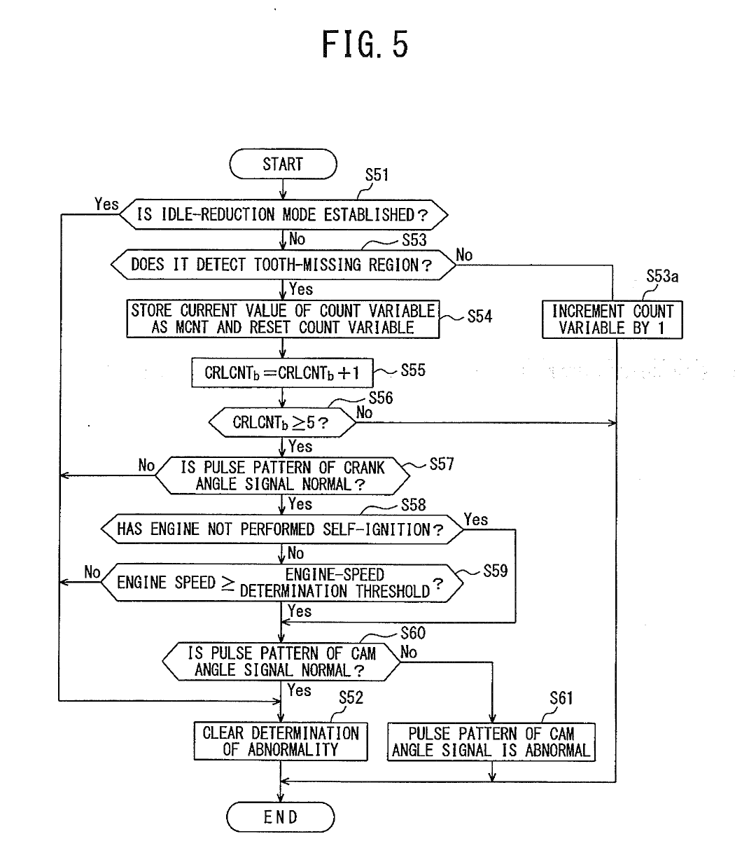

FIG. 5 schematically illustrates an example of specific operations of the second abnormality determining task carried out by the ECU 30. For example, the second abnormality determiner 35 performs the second abnormality determining task each time a pulse of the cam angle signal is input to the ECU 30.

Referring to FIG. 5, in step S51, the second abnormality determiner 35 determines whether the idle-reduction mode is established, in other words, whether the idle-reduction running flag is set to 1. Upon determination that the idle-reduction mode is established, the second abnormality determiner 35 carries out the operation in step S52. Otherwise, upon determination that the idle-reduction mode is non-established, the second abnormality determiner 35 carries out the operation in step S53.

In step S52, the second abnormality determiner 35 determines that the pulse pattern of the cam angle signal is normal, or clears, if it was determined that the pulse pattern of the cam angle signal was abnormal in step S61 described later before the current execution of the second abnormality determining task illustrated in FIG. 5, the determined result, thus determining that the pulse pattern of the cam angle signal is normal. Thereafter, the second abnormality determiner 35 terminates the second abnormality determining task illustrated in FIG. 5.

In step S53, the second abnormality determiner 35 determines whether to detect an irregular pulse interval corresponding to a tooth-missing region in the crank angle signal in the same approach as the operation in step S23.

Upon determination that no tooth-missing regions are detected, the second abnormality determiner 35 increments, by 1, a count variable indicative of the number of produced pulses of the cam angle signal in step S53a; the initial value of the count variable is set to zero. Thereafter, the second abnormality determiner 35 terminates the second abnormality determining task illustrated in FIG. 5. As a result, the count variable is incremented by 1 each time a produced pulse of the cam angle signal is input to the ECU 30 until it is determined that an irregular pulse interval corresponding to a tooth-missing region is detected in the crank angle signal.

Otherwise, upon determination that a tooth-missing region is detected, the second abnormality determiner 35 carries out the operation in step S54.

In step S54, the second abnormality determiner 35 stores the current value of the count variable in the storage 39 as a pulse-number count value MCNT, and resets the count variable to zero. Then, the second abnormality determiner 35 performs the operation in step S55.

In step S55, the second abnormality determiner 35 increments a tooth-missing count variable CRLCNTb by 1, which is expressed by CRLCNTb=CRLCNTb+1. Note that the tooth-missing count variable CRLCNTb is reset to zero each time the starter signal is turned from the off state to the on state.

Next, in step S56, the second abnormality determiner 35 determines whether the value of the tooth-missing count variable CRLCNTb is equal to or greater than 5.

Note that the second abnormality determiner 35 needs to obtain at least successive four pulse-number count values MCNT in order to perform the operation in step S60 described later. Thus, detection of five or more tooth-missing regions, i.e. detection of at least four irregular intervals, in the crank angle signal is needed. For this reason, the second abnormality determiner 35 performs the determination of whether the value of the tooth-missing count variable CRLCNTb is equal to or greater than 5.

Upon determination that the value of the tooth-missing count variable CRLCNTb is less than 5, the second abnormality determiner 35 terminates the second abnormality determining task illustrated in FIG. 5. As a result, the operations in steps S51 to S56 are performed each time a produced pulse of the crank angle signal is input to the ECU 30 until it is determined that the value of the tooth-missing count variable CRLCNTb is equal to or greater than 5. Thus, in the storage 39, the at least successive four pulse-number count values MCNT are stored.

Otherwise, upon determination that the value of the tooth-missing count variable CRLCNTb is equal to or greater than 5, the second abnormality determiner 35 carries out the operation in step S57.

In step S57, the second abnormality determiner 35 determines whether the pulse pattern of the crank angle signal is normal. For example, the second abnormality determiner 35 determines that the pulse pattern of the crank angle signal is normal if the first abnormality determiner 34 has not determined that the pulse pattern of the crank angle signal is abnormal. Upon determination that the pulse pattern of the crank angle signal is normal, the second abnormality determiner 35 performs the operation in step S58. Otherwise, upon determination that the first abnormality determiner 34 has determined that the pulse pattern of the crank angle signal is abnormal, the second abnormality determiner 35 performs the operation in step S52 set forth above.

In step S58, the second abnormality determiner 35 determines whether the engine has not performed self-ignition, i.e. is cranking by the starter motor. Upon determination that the engine has not performed self-ignition, the second abnormality determiner 35 performs the operation in step S60. Otherwise, upon determination that the engine has performed self-ignition, the second abnormality determiner 35 performs the operation in step S59.

In step S59, the second abnormality determiner 35 determines whether the engine speed calculated by the crank-angle detector 33 is equal to or greater than the engine-speed determination threshold. The engine-speed determination threshold is a value of the engine speed while rotation of the crankshaft 101 of the engine is stable. The engine-speed determination threshold is previously determined experimentally, empirically, and/or theoretically.

Upon determination that the engine speed is equal to or greater than the engine-speed determination threshold, the second abnormality determiner 35 carries out the operation in step S60. Otherwise, upon determination that the engine speed is less than the engine-speed determination threshold, the second abnormality determiner 35 carries out the operation in step S52.

In step S60, the second abnormality determiner 35 determines whether the pulse pattern of the cam angle signal is normal.

As described above, the normal pulse pattern of the cam angle is the repetition of the specified pulse pattern (1, 2, 0, 1).

Thus, in step S60, the second abnormality determiner 35 determines whether the numerical pattern of the at least successive four pulse-number count values MCNT matches with the normal pulse pattern as repetition of the specified pulse pattern (1, 2, 0, 1).

Upon determination that the numerical pattern of the at least successive four pulse-number count values MCNT matches with the normal pulse pattern as repetition of the specified pulse pattern (1, 2, 0, 1), the second abnormality determiner 35 determines that the pattern of produced pulses of the cam angle signal is normal. Then, the second abnormality determiner 35 performs the operation in step S52 set forth above.

Otherwise, upon determination that the numerical pattern of the at least successive four pulse-number count values MCNT mismatches with the normal pulse pattern as repetition of the specified pulse pattern (1, 2, 0, 1), the second abnormality determiner 35 performs the operation in step S61 to determine that the pulse pattern of the cam angle signal is abnormal. Then, the second abnormality determiner 35 terminates the second abnormality determining task illustrated in FIG. 5.

Next, a crank-angle position reviewing task carried out by the reviewing module 36 will be described hereinafter.

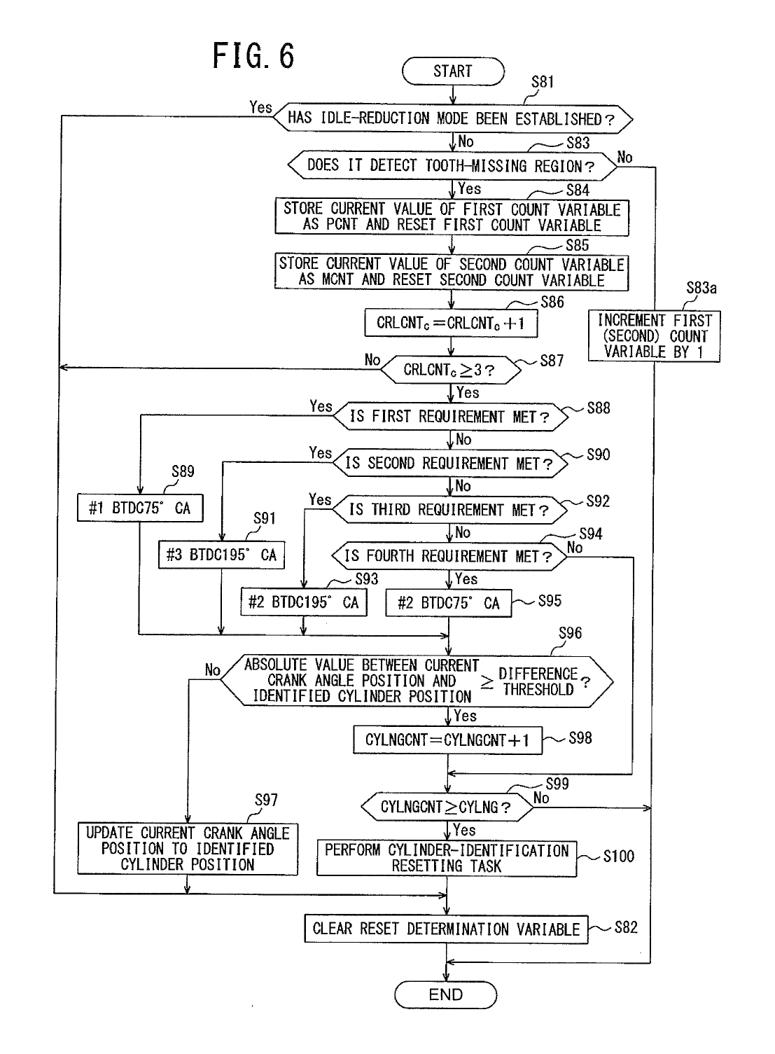

FIG. 6 schematically illustrates an example of specific operations of the crank-angle position reviewing task carried out by the ECU 30. For example, the reviewing module 36 performs the crank-angle position reviewing task each time a pulse of the crank angle signal is input to the ECU 30.

Referring to FIG. 6, in step S81, the reviewing module 36 determines whether the idle-reduction mode is established, in other words, whether the idle-reduction running flag is set to 1. Upon determination that the idle-reduction mode is established, the reviewing module carries out the operation in step S82. Otherwise, upon determination that the idle-reduction mode is non-established, the reviewing module 36 carries out the operation in step S83.

In step S82, the reviewing module 36 clears a value of a reset determination variable CYLNGCNT to zero, which was counted up in step S99 described later before the current execution of the crank-angle position reviewing task illustrated in FIG. 6. Thereafter, the reviewing module 36 terminates the crank-angle position reviewing task illustrated in FIG. 6.

In step S83, the reviewing module 36 determines whether to detect an irregular pulse interval corresponding to a tooth-missing region in the crank angle signal in the same approach as the operation in step S23.

Upon determination that no tooth-missing regions are detected, the reviewing module 36 increments, by 1, a first count variable indicative of the number of produced pulses of the crank angle signal in step S83a; the initial value of the first count variable is set to zero. Thereafter, the reviewing module 36 terminates the crank-angle position reviewing task illustrated in FIG. 6. As a result, the first count variable is incremented by 1 each time a produced pulse of the crank angle signal is input to the ECU 30 until it is determined that an irregular pulse interval corresponding to a tooth-missing region is detected in the crank angle signal.

At that time, if a pulse of the cam angle signal occurs at the same timing of the current pulse of the crank angle signal as the trigger of the current execution of the crank-angle position reviewing task, the reviewing module 36 increments, by 1, a second count variable indicative of the number of produced pulses of the cam angle signal in step S83a; the initial value of the second count variable is set to zero. Thereafter, the reviewing module 36 terminates the crank-angle position reviewing task illustrated in FIG. 6. As a result, the second count variable is incremented by 1 each time a produced pulse of the cam angle signal is input to the ECU 30 until it is determined that an irregular pulse interval corresponding to a tooth-missing region is detected in the crank angle signal.

Otherwise, upon determination that a tooth-missing region is detected, the reviewing module 36 carries out the operation in step S84.

In step S84, the reviewing module 36 stores the current value of the first count variable in the storage 39 as a pulse-number count value PCNT, and resets the first count variable to zero.

In step S85, the reviewing module 36 stores the current value of the second count variable in the storage 39 as a pulse-number count value MCNT, and resets the second count variable to zero.

In step S86, the reviewing module 36 increments a tooth-missing count variable CRLCNTc by 1, which is expressed by CRLCNTc=CRLCNTc+1. Note that the tooth-missing count variable CRLCNTc is reset to zero each time the starter signal is turned from the off state to the on state.

Next, in step S87, the reviewing module 36 determines whether the value of the tooth-missing count variable CRLCNTc is equal to or greater than 3 in the same approach as the operation in step S26.

Upon determination that the value of the tooth-missing count variable CRLCNTc is less than 3, the reviewing module 36 performs the operation in step S82, and thereafter, terminates the crank-angle position reviewing task illustrated in FIG. 6. As a result, the operations in steps S81 to S87 are performed each time a produced pulse of the crank angle signal is input to the ECU 30 until it is determined that the value of the tooth-missing count variable CRLCNTc is equal to or greater than 3. Thus, in the storage 39, at least the pulse-number count value PCNT0 corresponding to the latest tooth-missing region and the pulse-number count value PCNT1 corresponding to the tooth-missing region immediately before the latest tooth-missing region are stored.

Otherwise, upon determination that the value of the tooth-missing count variable CRLCNTc is equal to or greater than 3, the reviewing module 36 carries out the operation in step S88.

In step S88, the reviewing module 36 determines whether the pulse-number count value PCNT0, the pulse-number count value PCNT1, and the pulse-number count value MCNT meet first requirements for cylinder identification.

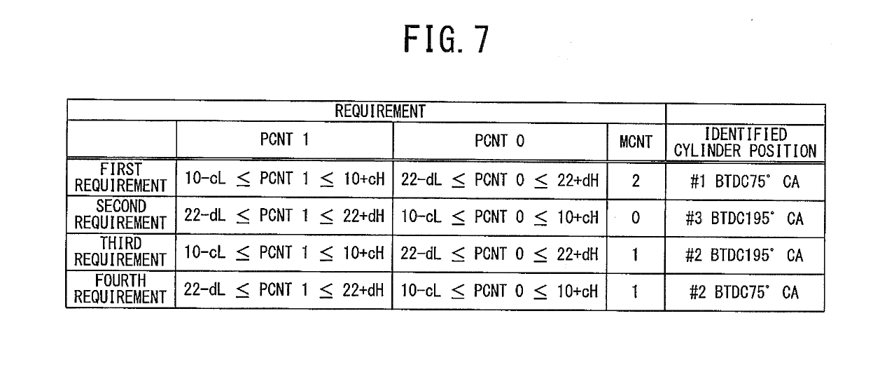

FIG. 7 schematically illustrates a table in which the first requirements for the pulse-number count value PCNT0, the pulse-number count value PCNT1, and the pulse-number count value MCNT are stored. Referring to FIG. 7, the first requirements for the pulse-number count value PCNT0, the pulse-number count value PCNT1, and the pulse-number count value MCNT are that:

10−cL≦PCNT1≦10+cH;

22−dL≦PCNT0≦22+dH; and

MCNT=2

where cL, cH, dL, and dH are margins of error previously determined based on noise components are contained in the crank angle signal and/or cam angle signal.

Upon determination that the pulse-number count value PCNT0, the pulse-number count value PCNT1, and the pulse-number count value MCNT satisfy the first requirements, the reviewing module 36 performs the operation in step S89. Otherwise, upon determination that at least one of the pulse-number count value PCNT0, the pulse-number count value PCNT1, and the pulse-number count value MCNT does not satisfy the first requirements, the reviewing module 36 performs the operation in step S90.

In step S89, the reviewing module 36 identifies the position of the cylinder #1 to 75° CA BTDC, i.e. the piston P in the cylinder #1 is located 75° CA before TDC. Thereafter, the reviewing module 36 performs the operation in step S96.

In step S90, the reviewing module 36 determines whether the pulse-number count value PCNT0, the pulse-number count value PCNT1, and the pulse-number count value MCNT meet second requirements for cylinder identification.

Referring to FIG. 7, the second requirements for the pulse-number count value PCNT0, the pulse-number count value PCNT1, and the pulse-number count value MCNT are that:

22−dL≦PCNT1≦22+dH;

10−cL≦PCNT0≦10+cH; and

MCNT=0

Upon determination that the pulse-number count value PCNT0, the pulse-number count value PCNT1, and the pulse-number count value MCNT satisfy the second requirements, the reviewing module 36 performs the operation in step S91. Otherwise, upon determination that at least one of the pulse-number count value PCNT0, the pulse-number count value PCNT1, and the pulse-number count value MCNT does not satisfy the second requirements, the reviewing module 36 performs the operation in step S92.

In step S91, the reviewing module 36 identifies the position of the cylinder #3 to 195° CA BTDC, i.e. the piston P in the cylinder #3 is located 195° CA before TDC. Thereafter, the reviewing module 36 performs the operation in step S96.

In step S92, the reviewing module 36 determines whether the pulse-number count value PCNT0, the pulse-number count value PCNT1, and the pulse-number count value MCNT meet third requirements for cylinder identification.

Referring to FIG. 7, the third requirements for the pulse-number count value PCNT0, the pulse-number count value PCNT1, and the pulse-number count value MCNT are that:

10−cL≦PCNT1≦10+cH;

22−dL≦PCNT0≦22+dH; and

MCNT=1

Upon determination that the pulse-number count value PCNT0, the pulse-number count value PCNT1, and the pulse-number count value MCNT satisfy the third requirements, the reviewing module 36 performs the operation in step S93. Otherwise, upon determination that at least one of the pulse-number count value PCNT0, the pulse-number count value PCNT1, and the pulse-number count value MCNT does not satisfy the third requirements, the reviewing module 36 performs the operation in step S94.

In step S93, the reviewing module 36 identifies the position of the cylinder #2 to 195° CA BTDC, i.e. the piston P in the cylinder #2 is located-195° CA before TDC. Thereafter, the reviewing module 36 performs the operation in step S96.

In step S94, the reviewing module 36 determines whether the pulse-number count value PCNT0, the pulse-number count value PCNT1, and the pulse-number count value MCNT meet fourth requirements for cylinder identification.

Referring to FIG. 7, the fourth requirements for the pulse-number count value PCNT0, the pulse-number count value PCNT1, and the pulse-number count value MCNT are that:

22−dL≦PCNT1≦22+dH;

10−cL≦PCNT0≦10+cH; and

MCNT=1

Upon determination that the pulse-number count value PCNT0, the pulse-number count value PCNT1, and the pulse-number count value MCNT satisfy the fourth requirements, the reviewing module 36 performs the operation in step S95. Otherwise, upon determination that at least one of the pulse-number count value PCNT0, the pulse-number count value PCNT1, and the pulse-number count value MCNT does not satisfy the fourth requirements, the reviewing module 36 performs the operation in step S99.

In step S95, the reviewing module 36 identifies the position of the cylinder #2 to 75° CA BTDC, i.e. the piston P in the cylinder #2 is located 75° CA before TDC. Thereafter, the reviewing module 36 performs the operation in step S96.

In step S96, the reviewing module 36 determines whether the absolute difference value between the current crank angle position detected by the crank-angle detector 33 and an identified cylinder position is equal to or greater than a difference threshold.

Note that the identified cylinder position is one of 75° CA BTDC of the cylinder #1, 195° CA BTDC of the cylinder #3, 195° CA BTDC of the cylinder #2, and 75° CA BTDC of the cylinder #2, which is obtained by a corresponding one of the operations in steps S89, S91, S93, and S94 immediately before execution of the operation in step S96. The difference threshold is previously determined experimentally, empirically, and/or theoretically.

The current crank angle position detected by the crank-angle detector 33 shows the current rotational position of the crankshaft 101. In contrast, the identified cylinder position shows a crank angle relative to TDC in a specified cylinder.

For this reason, the reviewing module 36 converts one of the current crank angle position and the identified cylinder position into a value that matches with the other thereof using, for example, a predetermined conversion formula or other similar information, and thereafter calculates the absolute difference value between the current crank angle position and the identified cylinder position. The reviewing module 36 can convert both the current crank angle position and the identified cylinder position into values that match with each other using, for example, a predetermined conversion formula or other similar information, and thereafter calculate the absolute difference value therebetween. The reviewing module 36 can directly calculate the absolute difference value between the current crank angle position and the identified cylinder position, and thereafter convert the absolute difference into a value that shows an actual absolute difference between the current crank angle position and the identified cylinder position using, for example, a predetermined conversion formula or other similar information. For example, in the first embodiment, the reviewing module 36 converts the identified cylinder position into a value that matches with the current crank angle position.

Upon determination that the absolute difference value between the current crank angle position and the converted value of the identified cylinder position is equal to or greater than the difference threshold, the reviewing module 36 performs the operation in step S98. Otherwise, upon determination that the absolute difference value is less than the difference threshold, the reviewing module 36 performs the operation in step S97.

In step S97, the reviewing module 36 reviews the current crank angle position to update the current crank angle position to the converted value of the identified cylinder position obtained by any one of the operations in steps S89, S91, S93, and S94. Then, the reviewing module 36 stores the updated crank angle position in the storage 39, and thereafter, performs the operation in step S82.

In step S98, the reviewing module 36 increments the reset determination variable CYLNGCNT by 1, which is expressed by CYLNGCNT=CYLNGCNT+1; the initial value of the reset determination variable CYLNGCNT is zero.

Next, in step S99, the reviewing module 36 determines whether the value of the reset determination variable CYLNGCNT is equal to or greater than a reset determination threshold CYLNG. Upon determination that the value of the reset determination variable CYLNGCNT is equal to or greater than the reset determination threshold CYLNG, the reviewing module 36 carries out the operation in step S100. Otherwise, upon determination that the value of the reset determination variable CYLNGCNT is less than the reset determination threshold CYLNG, the reviewing module 36 terminates the crank-angle position reviewing task illustrated in FIG. 6.

In step S100, the reviewing module 36 performs a cylinder-identification resetting task. How to perform the cylinder-identification resetting task will be described in detail later. Thereafter, the reviewing module 36 clears the value of the reset determination variable CYLNGCNT to zero in step S82, terminating the crank-angle position reviewing task illustrated in FIG. 6.

Next, operations of the engine control system 1 will be described hereinafter.

First, operations of the engine control system 1 based on the determining task illustrated in FIG. 3 will be described.

The engine control system 1 establishes the idle-reduction mode when determining that the operation mode of the vehicle can be shifted to the idle-reduction mode, and starts the idle-reduction task by, for example, outputting an instruction to the fuel-injection controller 37 to instruct the fuel-injection controller 37 to cut fuel supply (see step S1). The engine control system 1 sets the idle-reduction running flag to 1, which shows that the idle-reduction mode is established (see step S2).

The engine control system 1 updates the rotational position of the crankshaft 101 stored in the storage 39 each time a new one is detected by the crank-angle detector 33 during the idle-reduction running flag being set to 1 (see steps S3 and S4). Specifically, the engine control system 1 updates the rotational position of the crankshaft 101 each time a new one is detected by the crank-angle detector 33 during the idle-reduction running flag being set to 1 until rotation of the engine, i.e. rotation of the crankshaft 101, is stopped.

Thereafter, the engine control system 1 sets the idle-reduction running flag to 0 if the starter signal is in the on state or the idle-reduction mode is non-established (see steps S5 to S7). Specifically, the idle-reduction controller 31 can cause the engine to be restarted by itself without an aid of the starter motor SM. Thus, the engine control system 1 sets the idle-reduction running flag to 0 if the idle-reduction mode is non-established although the starter signal is OFF. In other words, the engine control system 1 sets the idle-reduction running flag to 0 when a predetermined restart condition is met, in other words, when the engine is restarted.

As described above, the engine control system 1 determines that the idle-reduction mode is established during execution of the idle-reduction task, and that the idle-reduction mode is non-established when the starter signal is in the on state for restart of the engine or the engine is restated by itself to rotate the crankshaft 101 in the forward direction.

Next, operations of the engine control system 1 based on the first abnormality determining task illustrated in FIG. 4 will be described. The engine control system 1 continuously performs the first abnormality determining task while the idle-reduction mode is non-established (see steps S23 to S31 while the determination in step S21 is NO).

Specifically, when an engine restart condition is met during execution of the idle-reduction task, so that the idle-reduction mode is non-established, the engine control system 1 eliminates the ban on execution of the first abnormality determining task, and executes the first abnormality determining task.

When the engine control system 1 detects three irregular pulse intervals corresponding to three tooth-missing portions while the engine has not performed self-ignition, i.e. the engine is cranking by the starter motor SM, the engine control system 1 performs the determination of whether the pulse pattern of the crank angle signal is abnormal (see steps S23 to S27, S29, and S30).

Specifically, the engine control system 1 determines that the pulse pattern of the crank angle signal is abnormal if the pulse-number count value PCNT0 corresponding to the latest tooth-missing region and the pulse-number count value PCNT1 corresponding to the tooth-missing region immediately before the latest tooth-missing region does not meet a predetermined requirement (see NO in each of steps S29 and S30 and step S31). Otherwise, the engine control system 1 determines that the pulse pattern of the crank angle signal is normal, i.e. clears the determined result that the pulse pattern of the crank angle signal is abnormal if the pulse-number count value PCNT0 corresponding to the latest tooth-missing region and the pulse-number count value PCNT1 corresponding to the tooth-missing region immediately before the latest tooth-missing region meet the predetermined requirement (see YES in step S29 or S30 and step S22).

In addition, when the engine control system 1 detects three irregular pulse intervals corresponding to three tooth-missing portions while the speed of the engine after self-ignition is equal to or higher than the engine-speed determination threshold, the engine control system 1 performs the determination of whether the crank angle signal is abnormal (see steps S23 to S31).

Specifically, the engine control system 1 determines that the pulse pattern of the crank angle signal is abnormal if the pulse-number count value PCNT0 corresponding to the latest tooth-missing region and the pulse-number count value PCNT1 corresponding to the tooth-missing region immediately before the latest tooth-missing region does not meet the predetermined requirement (see NO in each of steps S29 and S30 and step S31).

Otherwise, the engine control system 1 determines that the pulse pattern of the crank angle signal is normal, i.e. clears the determined result that the pulse pattern of the crank angle signal is abnoi vial if the pulse-number count value PCNT0 corresponding to the latest tooth-missing region and the pulse-number count value PCNT1 corresponding to the tooth-missing region immediately before the latest tooth-missing region meet the predetermined requirement (see YES in step S29 or S30 and step S22).

As described above, the engine control system 1 determines whether the pulse pattern of the crank angle signal is abnormal based on the pulse-number count value PCNT0 corresponding to the latest tooth-missing region and the pulse-number count value PCNT1 corresponding to the tooth-missing region immediately before the latest tooth-missing region.

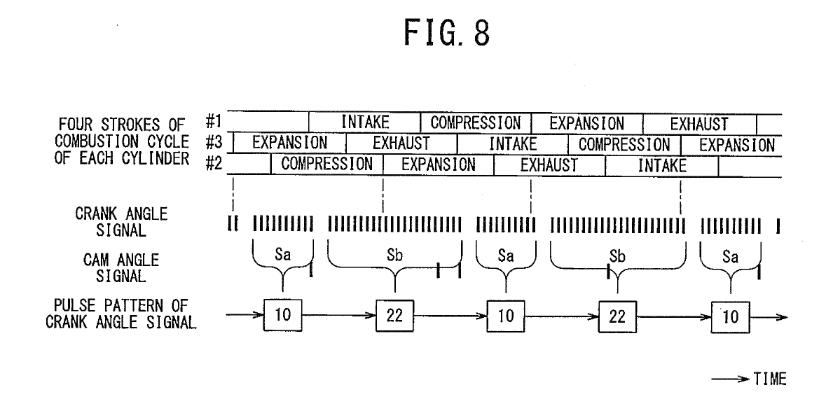

FIG. 8 schematically illustrates the pulse pattern of the crank angle signal according to the first embodiment when the crank angle sensor 2 normally operates, i.e. the crankshaft 101 turns in the forward direction; the number of pulses of the crank angle signal occurring within the regular pulse sections Sa and Sb can be denoted by an expression “pulse pattern (j1, j2, . . . )”. In the first embodiment, the pulse pattern of the crank angle signal shown in FIG. 8 would be described as “pulse pattern (10, 22, 10, 22, 10 . . . )”. Specifically, ten pulses within the regular pulse section Sa and twenty-two pulses within the regular pulse section Sb occur alternately.

On the other hand, while the idle-reduction mode is established, the engine control system 1 determines that the pulse pattern of the crank angle signal is nor vial, or clears the determined result representing that the pulse pattern of the crank angle signal is abnormal without performing the first abnormality determining task set forth above, thus determining that the pulse pattern of the crank angle signal is normal (see YES in step S21 and step S22).

Specifically, reverse rotation of the crankshaft 101 when the engine is stopped based on the idle-reduction task may cause the engine control system 1 to erroneously detect tooth-missing regions in the crank angle signal. Erroneously detected tooth-missing regions may cause the engine control system 1 to mistakenly determine that there is an abnormality in the crank angle signal.

In view of the circumstances, while the idle-reduction mode in which the idle-reduction task is executed to stop the engine is established, the engine control system 1 disables execution of the first abnormality determining task, specifically, the operations in steps S23 to S31. This prevents the engine control system 1 from erroneously detecting tooth-missing regions, thus preventing the engine control system 1 from mistakenly determining that there is an abnormality in the crank angle signal.

If the speed of the engine after self-ignition is less than the engine-speed determination threshold, the engine control system 1 clears the determined result representing that the pulse pattern of the crank angle signal is abnormal without performing the first abnormality determining task, i.e. the operations in steps S29 to S31 (see NO in step S28 and step S22).

If the engine is cranked by the starter motor SM so that the engine has not performed self-ignition, the engine control system 1 does not clear the determined result representing that the pulse pattern of the crank angle signal is abnormal even if the speed of the engine after self-ignition is less than the engine-speed determination threshold (see skip of the operation in step S28 and the operations in steps S29 and S30). This is because, while the engine is cranked by the starter motor SM, rotation of the crankshaft 101 is kept stable and misdetection of tooth-missing regions is avoided even if the engine speed is less than the engine-speed determination threshold.

Next, operations of the engine control system 1 based on the second abnormality determining task illustrated in FIG. 5 will be described.

The engine control system 1 continuously performs the second abnormality determining task while the idle-reduction mode is non-established (see steps S53 to S61 while the determination in step S51 is NO).

Specifically, when an engine restart condition is met during execution of the idle-reduction task, so that the idle-reduction mode is non-established, the engine control system 1 eliminates the ban on execution of the second abnormality determining task, and executes the second abnormality determining task.

When the engine control system 1 detects five irregular pulse intervals corresponding to five tooth-missing portions while the pulse pattern of the crank angle signal is normal and the engine has not performed self-ignition, the engine control system 1 performs the determination of whether the pulse pattern of the cam angle signal is abnormal (see steps S53 to S58, S60, and S61).

Specifically, the engine control system 1 determines that a detected pulse pattern of the cam angle signal is abnormal if the numerical pattern of the detected latest four pulse-number count values MCNT as the detected pulse pattern of the cam angle signal mismatches with the normal pulse pattern defined as repetition of the specified pulse pattern (see steps S53 to S58, S60, and S61). Otherwise, the engine control system 1 determines that a detected pulse pattern of the cam angle signal is normal or clears the determination that the pulse pattern of the cam angle signal is abnormal, if the numerical pattern of the detected latest four pulse-number count values MCNT as the detected pulse pattern of the cam angle signal matches with the normal pulse pattern of the cam angle signal (see steps S53 to S58, S60, and S52).

In addition, when the engine control system 1 detects five irregular pulse intervals corresponding to five tooth-missing portions while the pulse pattern of the crank angle signal is normal and the engine speed after self-ignition is equal to or greater than the engine-speed determination threshold, the engine control system 1 performs the determination of whether the pulse pattern of the cam angle signal is abnormal (see steps S53 to S60).

Specifically, the engine control system 1 determines that a detected pulse pattern of the cam angle signal is abnormal if the numerical pattern of the detected latest four pulse-number count values MCNT, which represents the detected pulse pattern of the cam angle signal, mismatches with the normal pulse pattern of the cam angle signal (see steps S53 to S61).

Otherwise, the engine control system 1 determines that a detected pulse pattern of the cam angle signal is normal, i.e. clears the determination that the pulse pattern of the cam angle signal is abnolinal, if the numerical pattern of the detected latest four pulse-number count values MCNT, which represents the detected pulse pattern of the cam angle signal, matches with the normal pulse pattern of the cam angle signal (see steps S53 to S60, and S52).

Specifically, the engine control system 1 determines whether the numerical pattern based on the detected latest four pulse-number count values MCNT is abnormal by comparison between the numerical pattern and the normal pulse pattern of the cam angle signal.

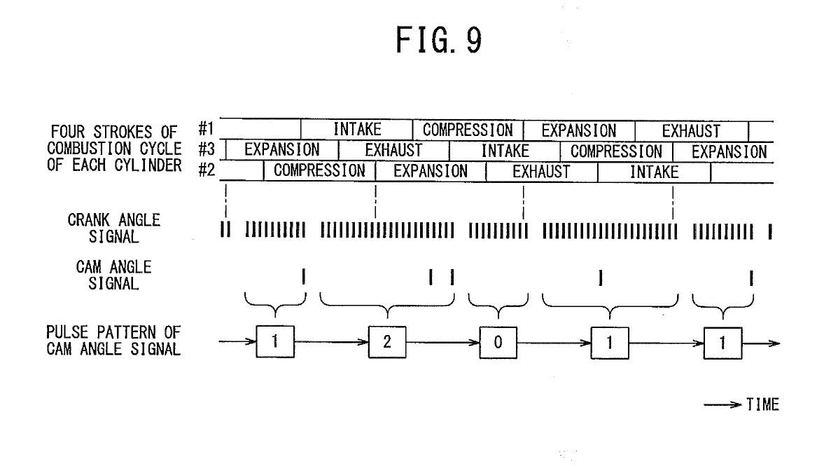

FIG. 9 schematically illustrates the normal pulse pattern of the cam angle signal according to the first embodiment when the crank angle sensor 2 normally operates, i.e. the crankshaft 101 turns in the forward direction. As illustrated in FIG. 9, the normal pulse pattern of the cam angle signal shown in FIG. 9 would be described as repetition of the specified pulse pattern (1, 2, 0, 1).

Specifically, if the numerical pattern based on the detected latest four pulse-number count values MCNT of the cam angle signal is matched with the normal pulse pattern as repetition of the specified pulse pattern (1, 2, 0, 1), the detected pulse pattern of the cam angle signal is determined to be normal.

On the other hand, while the idle-reduction mode is established, the engine control system 1 clears the determined result representing that the pulse pattern of the cam angle signal is abnormal without performing the second abnormality determining task set forth above (see YES in step S51 and step S52).

Specifically, reverse rotation of the crankshaft 101 when the engine is stopped based on the idle-reduction task may cause the engine control system 1 to erroneously detect tooth-missing regions in the crank angle signal. Erroneously detected tooth-missing regions may cause the engine control system 1 to mistakenly determine that there is an abnormality in the cam angle signal.

In view of the circumstances, while the idle-reduction mode in which the idle-reduction task is executed to stop the engine is established, the engine control system 1 disables execution of the second abnormality determining task, specifically, the operations in steps S53 to S61. This prevents the engine control system 1 from erroneously detecting tooth-missing regions, thus preventing the engine control system 1 from mistakenly determining that there is an abnormality in the cam angle signal.

If the speed of the engine after self-ignition is less than the engine-speed determination threshold, the engine control system 1 clears the determined result representing that the pulse pattern of the cam angle signal is abnormal without performing the second abnormality determining task, i.e. the operations in steps S59 to S52 (see NO in step S58 and step S52).

If the engine is cranked by the starter motor SM so that the engine has not performed self-ignition, the engine control system 1 does not clear the determined result representing that the pulse pattern of the cam angle signal is abnormal even if the speed of the engine after self-ignition is less than the engine-speed determination threshold (see skip of the operation in step S58 and the operations in steps S59 and S60). This is because, while the engine is cranked by the starter motor SM, rotation of the crankshaft 101 is kept stable and misdetection of tooth-missing regions is avoided even if the engine speed is less than the engine-speed determination threshold.

Next, operations of the engine control system 1 based on the crank-angle position reviewing task illustrated in FIG. 6 will be described. The engine control system 1 continuously performs the crank-angle position reviewing task while the idle-reduction mode is not established (see steps S83 to S100 and S82 while the determination in step S81 is NO).

Specifically, when an engine restart condition is met during execution of the idle-reduction task, so that the idle-reduction mode is not established, the engine control system 1 eliminates the ban on execution of the cylinder identification task, and executes the cylinder identification task.

When the engine control system 1 detects three irregular pulse intervals corresponding to three tooth-missing portions, the engine control system 1 compares the pulse-number count value PCNT0, the pulse-number count value PCNT1, and the pulse-number count value MCNT with each of the first to fourth requirements for cylinder identification, thus identifying the position of a corresponding cylinder based on the compared results (see steps S83 to S95).

Next, the engine control system 1 updates the current crank angle position to the identified cylinder position to store it in the storage 39 if it is determined that the absolute difference value between the current crank angle position and the converted value of the identified cylinder position is less than the difference threshold, and thereafter, clears the value of the reset determination variable CYLNGCNT to zero (see steps S96, S97, and S82).

Otherwise, if it is determined that the absolute difference value between the current crank angle position and the converted value of the identified cylinder position is equal to or greater than the difference threshold, the engine control system 1 does not execute update of the current crank angle position based on the identified cylinder position (see steps S96 and S98). If the absolute difference value between the current crank angle position and the converted value of the identified cylinder position is equal to or greater than the difference threshold, at least one of the pulse-number count value PCNT0, the pulse-number count value PCNT1, and the pulse-number count value MCNT may vary due to noise or another factor. Thus, in this case, eliminating update of the current crank angle position based on the identified cylinder position prevents the current crank angle position from being erroneously updated due to noise.

If the number that the absolute difference value between the current crank angle position and the converted value of the identified cylinder position is equal to or greater than the difference threshold for each of successive executions of the crank-angle position reviewing task, the engine control system 1 performs the cylinder-identification resetting task, and thereafter, clears the value of the reset determination variable CYLNGCNT to zero (see steps S96, S98, S100, and S82).

As the cylinder-identification resetting task, the engine control system 1 clears info illation obtained in the current execution of the crank-angle position reviewing task, which includes the identified cylinder position. As the cylinder-identification resetting task, the engine control system 1 also clears the results obtained in the previous executions of the crank-angle position reviewing task, which include one or more previous updated crank angle positions obtained in the previous executions of the crank-angle position reviewing task. Thus, after execution of the cylinder-identification resetting task, the engine control system 1 performs the crank-angle position reviewing task while the pulse-number count value PCNT0, the pulse-number count value PCNT1, and the pulse-number count value MCNT are zero.

If the number that the absolute difference value between the current crank angle position and the converted value of the identified cylinder position is equal to or greater than the difference threshold for each of successive executions of the crank-angle position reviewing task, there is a high possibility of improper identification of the position of each cylinder. Thus, in such a situation, the engine control system 1 performs the cylinder-identification resetting task to clear the information obtained in the previous executions of the crank-angle position reviewing task.

On the other hand, while the idle-reduction mode is established, the engine control system 1 clears the value of the reset determination variable CYLNGCNT to zero without performing the operations in steps S83 to S100 (see steps S81 and S82).

As described above, the engine control system 1 performs the crank-angle position reviewing task each time a pulse of the crank angle signal is produced in the engine control system 1.

Reverse rotation of the crankshaft 101 when the engine is stopped based on the idle-reduction task may cause the engine control system 1 to erroneously detect tooth-missing regions in the crank angle signal. Erroneously detected tooth-missing regions may cause the engine control system 1 to mistakenly review identification of the position of a corresponding cylinder at the restart of the engine after its automatic stop.

In view of the circumstances, while the idle-reduction mode in which the idle-reduction task is executed to stop the engine is established, the engine control system 1 disables execution of the crank-angle position reviewing task, specifically, the operations in steps S83 to S100 and S82. This prevents the engine control system 1 from erroneously detecting tooth-missing regions, thus preventing the engine control system 1 from mistakenly reviewing the identified position of a corresponding cylinder at the restart of the engine after its automatic stop.

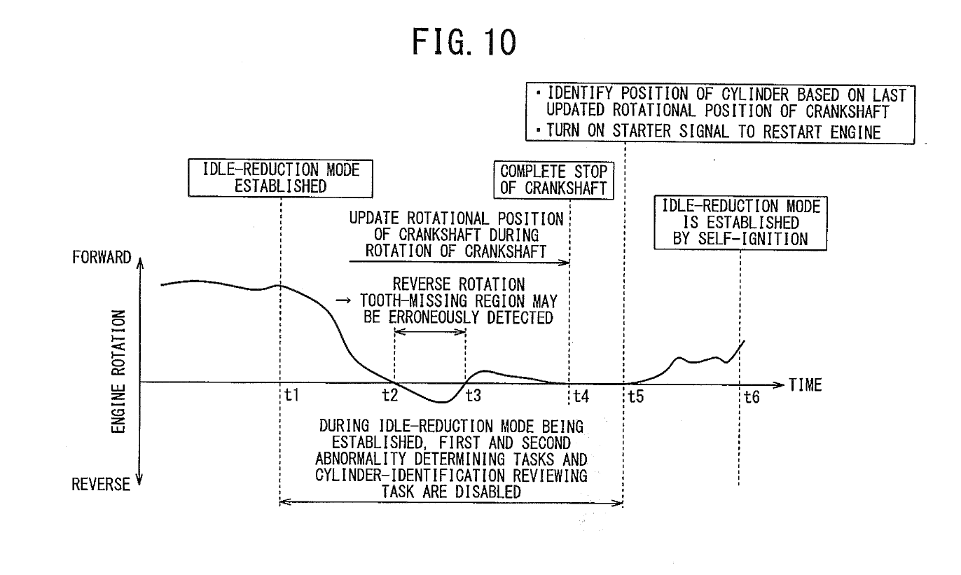

Next, an example of sequential operations of the engine control system 1 will be described hereinafter with reference to FIG. 10.

At time t1, the engine control system 1 establishes the idle-reduction mode for automatic stop of the engine. When the idle-reduction mode is established, the engine control system 1 disables execution of the first abnormality determining task, the second abnormality determining task, and the crank-angle position reviewing task for the period from the time t1 to time t5 during which the idle-reduction mode in which the idle-reduction task is executed to stop the engine is established, so that the engine speed is reduced; the time t5 represents the timing when the starter signal is turned from the off state to the one state for restart of the engine. Specifically, the engine control system 1 disables the operations in step S23 to S31 of the first abnormality determining task, the operations in steps S53 to S61 of the second abnormality determining task, and the operations in steps S83 to S100 and S82 of the crank-angle position reviewing task.

Specifically, the engine control system 1 disables execution of the first abnormality determining task, the second abnormality determining task, and the crank-angle position reviewing task for the period from time t2 to time t3 during which the engine control system 1 may erroneously detect tooth-missing regions due to reverse rotation of the crankshaft 101. This makes it possible to:

prevent the engine control system 1 from mistakenly determining that the pulse pattern of the crank angle signal or that of the cam angle signal is abnormal; and

prevent the engine control system 1 from mistakenly reviewing the identified position of each cylinder.

In addition, even if the idle-reduction mode is established, the engine control system 1 updates the rotational position of the crankshaft 101 stored in the storage 39 each time a new one is detected by the crank-angle detector 33 until rotation of the crankshaft 101 is completely stopped (see the period up to time t4). When rotation of the crankshaft 101 is completely stopped, the engine control system 1 identifies the position of a corresponding cylinder based on the last updated rotational position of the crankshaft 101 stored in the storage 39 at the complete stop of the crankshaft 101, thus turning the starter signal from the off state to the on state to restart the engine at the time t5.

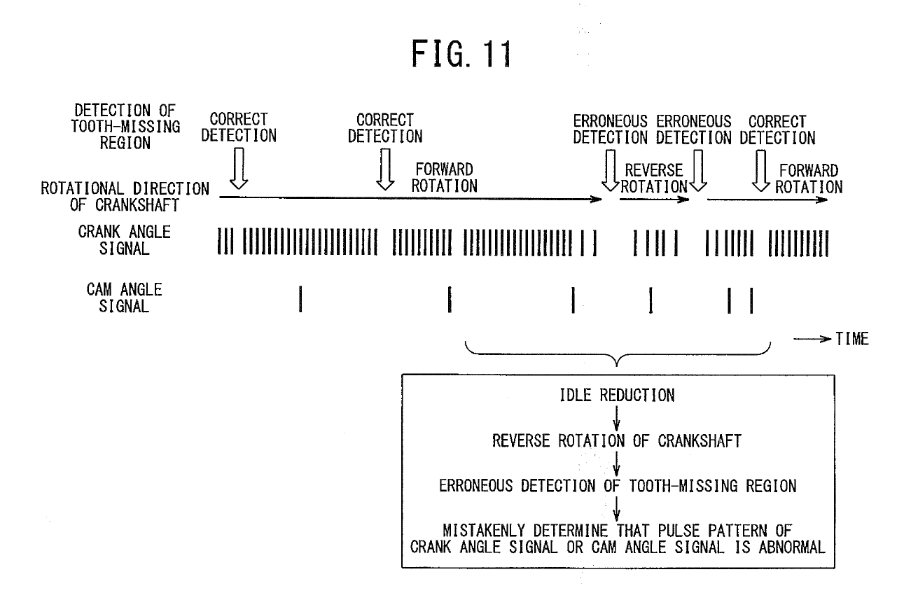

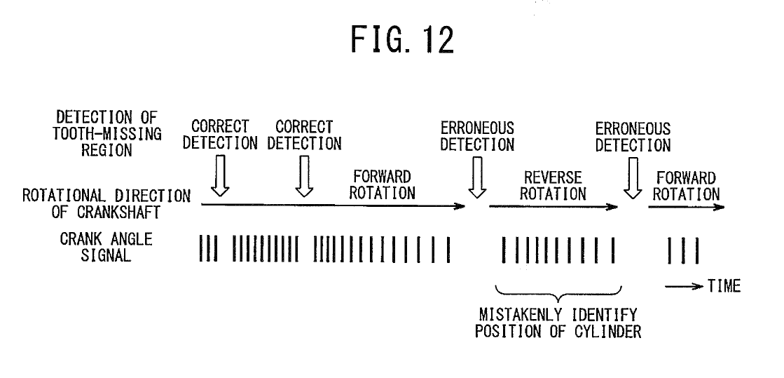

Next, cases where tooth-missing regions are erroneously detected will be described with reference to FIGS. 11 and 12. FIG. 11 shows the first case where erroneously detected tooth-missing regions result in the pulse pattern of the crank angle signal or that of the cam angle signal being mistakenly determined to be abnormal. FIG. 12 shows the second case where erroneously detected tooth-missing regions cause the identified position of a corresponding cylinder to be mistakenly reviewed.

In the first case, as illustrated in FIG. 11, reverse rotation of the crankshaft 101 based on the idle-reduction task may cause the engine control system 1 to erroneously detect a tooth-missing region due to a longer interval in the crank angle signal during which no pulses are detected. This may cause the engine control system 1 to mistakenly determine that the pulse pattern of the crank angle signal or that of the cam angle signal is abnormal.

In the second case, as illustrated in FIG. 12, reverse rotation of the crankshaft 101 based on the idle-reduction task may cause the engine control system 1 to erroneously detect a tooth-missing region due to a longer interval in the crank angle signal during which no pulses are detected. This may cause the engine control system 1 to mistakenly identity the position of a corresponding cylinder based on the counted number of pulses in the longer interval, i.e. false tooth-missing region, which is erroneously detected as a tooth-missing region.

In the first embodiment, for example, the crank angle sensor 2 serves as a signal output module configured to produce pulses based on rotation of the crankshaft 101, and output a signal having the pulses, a pattern of the pulses showing at least one reference portion, i.e. a tooth-missing portion, of the crankshaft 101 to which a position of the at least one cylinder is relative. The operations in steps S23 to S26, the operations in steps S53 to S56, and the operations in steps S83 to S86, carried out by the ECU 30, serve as, for example, a reference portion detector configured to perform a reference portion detecting task that detects, based on the pattern of the pulses of the signal during rotation of the crankshaft 101 in a predetermined direction, the at least one reference portion, i.e. the at least one tooth-missing region, of the crankshaft 101.

The idle-reduction mode determiner 32, and the operation in step S21, the operation in step S31, and the operation in step S81 serve as, for example, a reverse rotation predicting module configured to predict whether rotation of the crankshaft 101 in the predetermined direction will be reversed.

The skipping of the operations in steps S23 to S31 (affirmative determination in step S21), the operations in steps S33 to S61 (affirmative determination in step S31), and those in steps S83 to S100 (affirmative determination in step S81), carried out by the ECU 30, serves as, for example, a disabling module configured to disable the reference portion detector from performing the reference portion detecting task if the reverse rotation predicting module predicts that rotation of the crankshaft 101 in the predetermined direction will be reversed. Particularly, skipping the reference portion detecting task (operations in steps S23 to S26, the operations in steps S33 to S36, and those in steps S83 to S86) serves as, for example, the disabling module.

The first abnormality determiner 34 serves as, for example, an abnormality determiner configured to perfoi tai an abnormality determining task that determines whether there is an abnormality in the pattern of the pulses of the signal based on the at least one reference portion of the crankshaft 101. The idle-reduction mode determiner 32 serves as, for example, an engine start detector. The idle-reduction mode determiner 32 and the negative determinations in step S21, S31, and S81 serve as an enabling module configured to enable the reference portion detector to perform the reference portion detecting task if the engine start detector is configured to detect that the engine is started.

The reviewing module 36 serves as, for example, a cylinder-position identifying module configured to perform a cylinder-position identifying task that identifies the position of the at least one cylinder based on the signal output from the signal output module. The crank-angle detector 33 and the operation in step S4 carried out by the idle-reduction mode determiner 32 serve as, for example, a rotational position updating module configured to update a rotational position of the crankshaft 101 based on the signal output from the signal output module.

The cam-angle sensor 3 serves as, for example, a cam-signal output module configured to produce pulses based on rotation of the camshaft 102, and output a cam-signal having the pulses.

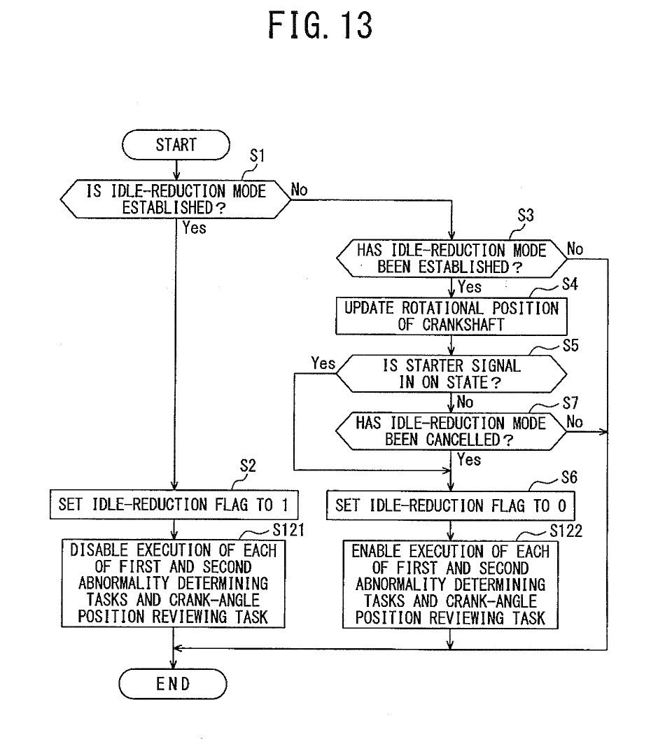

The idle-reduction mode determining task carried out by the ECU 30 is not limited to that illustrated in FIG. 3. Specifically, another example of the idle-reduction mode determining task is illustrated in FIG. 13 as a modification of the first embodiment.

As illustrated in FIG. 13, the idle-reduction mode determiner 32 performs the operation in step S121 after the operation in step S2, and performs the operation in step S122 after the operation in step S6.

In step S121, the idle-reduction mode determiner 32 disables execution of each of the first and second abnormality determining tasks, and execution of the crank-angle position reviewing task. In step S122, the idle-reduction mode determiner 32 enables execution of each of the first and second abnormality determining tasks, and execution of the crank-angle position reviewing task. Thus, in the modification, the engine control system 1 performs the determination of whether to disable execution of each of the first abnormality determining task, the second abnormality determining task, and the crank-angle position reviewing task, which are performed in the operations S21, S51, and S81, based on the operations in steps S121 and S122. The first abnormality determining task described in each of steps S121 and S122 corresponds to the operations in steps S23 to S31 illustrated in FIG. 4, and the second abnormality determining task described in each of steps S121 and S122 corresponds to the operations in steps S53 to S61 illustrated in FIG. 5. The crank-angle position reviewing task described in each of steps S121 and S122 corresponds to the operations in steps S83 to S100 and S82 illustrated in FIG. 6.

In the first embodiment, a three-cylinder internal combustion engine is used as a controlled target by the engine control system 1, but a multi-cylinder internal combustion engine can be used as a controlled target by the engine control system 1. In the first embodiment, the first abnormality determining task is not limited to the specific operations illustrated in FIG. 4, the second abnormality determining task is not limited to the specific operations illustrated in FIG. 5, and the crank-angle position reviewing task is not limited to the specific operations illustrated in FIG. 6.

Specifically, as the first abnormality determining task, a task that can determine whether there is an abnormality in the pulse pattern of the crank angle signal can be used, and as the second abnormality determining task, a task that can determine whether there is an abnormality in the pulse pattern of the cam angle signal can be used. As the crank-angle position reviewing task, a task that can:

identify the position of a corresponding cylinder based on the crank angle signal output from the crank angle sensor 2;

review the current crank angle position based on the identified position of a corresponding cylinder if the idle-reduction mode is not established; and

disable reviewing the current crank angle position if the idle-reduction mode is established.

As the specific numerical values used in the first embodiment, other numerical values can be used.

### Second Embodiment

Let us describe an engine control system 1A according to a second embodiment hereinafter. Like parts between the first and second embodiments, to which like reference characters are assigned, are omitted or simplified in description to avoid redundant description.

The engine control system 1A according to the second embodiment is configured to disable execution of each of the first abnormality determining task, the second abnormality determining task, and the crank-angle position reviewing task while an ignition switch is in an off state. Driver's operation of the ignition switch can energize and deenergize the electrical system of the engine. Specifically, when the ignition switch is operated to be turned from the on state to the off state, the engine is stopped and cannot be started. On the other hand, when the ignition switch is turned from the off state to the on state, the engine can be started.

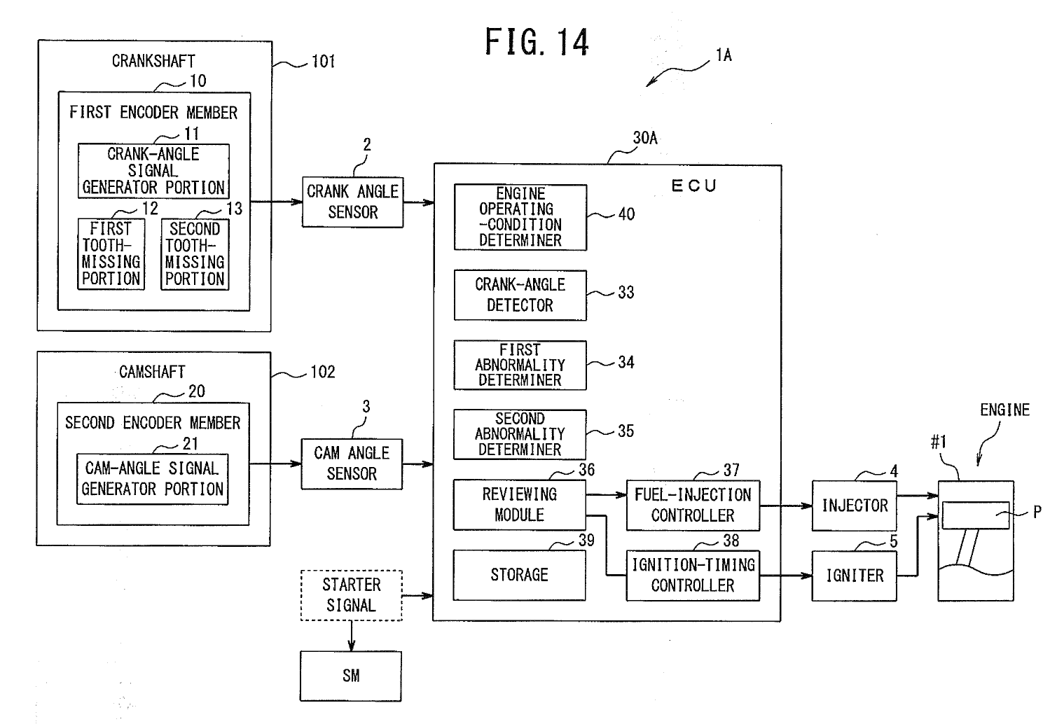

FIG. 14 schematically illustrates a structural example of an ECU 30A according to the second embodiment. Referring to FIG. 14, the ECU 30A includes an engine operating-condition determiner 40 for controlling the operating conditions of the engine.

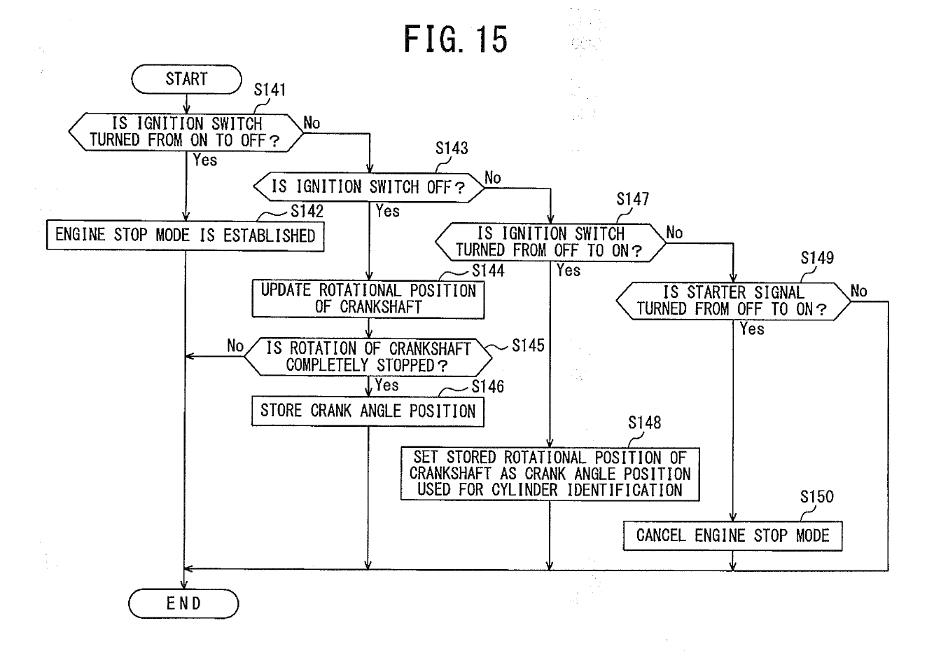

FIG. 15 schematically illustrates an example of specific operations of an engine stop-mode determining task carried out by the ECU 30A. For example, the engine operating-condition controller 40 performs the engine stop-mode determining task every 10 milliseconds [ms].

Referring to FIG. 15, in step S141, the engine operating-condition controller 40 determines whether the ignition switch is turned from the on state to the off state.

Upon determination that the ignition switch is turned from the on state to the off state, the engine operating-condition controller 40 performs the operation in step S142. Otherwise, upon determination that the ignition switch is not turned from the on state to the off state, the engine operating-condition controller 40 performs the operation in step S143.

In step S142, the engine operating-condition controller 40 outputs an instruction to stop the engine, such as an instruction to cut fuel into the injectors of the engine, to the fuel-injection controller 37, thus starting a control task for stopping the engine. Then, the engine operating-condition controller 40 establishes an engine stop mode showing that the engine is stopped. After the operation in step S142, the engine operating-condition controller 40 terminates the engine stop-mode determining task illustrated in FIG. 15.

In step S143, the engine operating-condition controller 40 determines whether the ignition switch is in the off state. Upon determination that the ignition switch is in the off state, the engine operating-condition controller 40 carries out the operation in step S144. Otherwise, upon determination that the ignition switch is not in the off state, the engine operating-condition controller 40 carries out the operation in step S147.

In step S144, the engine operating-condition controller 40 updates the rotational position of the crankshaft 101 stored in the storage 39 each time a new one is detected by the crank-angle detector 33.

Next, the engine operating-condition controller 40 determines whether rotation of the crankshaft 101 is completely stopped in step S145. Upon determination that rotation of the crankshaft 101 is completely stopped, the engine operating-condition controller 40 carries out the operation in step S146. Otherwise, upon determination that rotation of the crankshaft 101 is not completely stopped, the engine operating-condition controller 40 terminates the engine stop-mode determining task illustrated in FIG. 15.

In step S146, the engine operating-condition controller 40 stores the crank angle position detected by the crank-angle detector 33 at the timing when rotation of the crankshaft 101 is completely stopped. Thereafter, the engine operating-condition controller 40 terminates the engine stop-mode determining task illustrated in FIG. 15.

In step S147, the engine operating-condition controller 40 determines whether the ignition switch is turned from the off state to the on state. Upon determination that the ignition switch is turned from the off state to the on state, the engine operating-condition controller 40 performs the operation in step S148. Otherwise, upon determination that the ignition switch is not turned from the off state to the on state, i.e. the ignition switch is in the on state, the engine operating-condition controller 40 performs the operation in step S149.

In step S148, the engine operating-condition controller 40 sets the crank angle position stored in the storage 39, i.e. the crank angle position detected by the crank-angle detector 33 at the timing when rotation of the crankshaft 101 is completely stopped, as a crank angle position used for cylinder identification at the restart of the engine. Thereafter, the engine operating-condition controller 40 terminates the engine stop-mode determining task illustrated in FIG. 15.

In step S149, the engine operating-condition controller 40 determines whether the starter signal is turned from the off state to the on state. Upon determination that the starter signal is turned from the off state to the on state, the engine operating-condition controller 40 determines that the engine is being cranked, performing the operation in step S150. Otherwise, upon determination that the starter signal is not turned from the off state to the on state, i.e. is kept in the off state, the engine operating-condition controller 40 determines that the engine operates in the normal mode, terminating the engine-activation determining task illustrated in FIG. 15.

In step S150, the engine operating-condition controller 40 determines that the engine is being cranked, and cancels the established engine stop mode in step S150, terminating the engine stop-mode determining task illustrated in FIG. 15.

In the second embodiment, the first abnormality determiner 34 is configured to determine whether to execute the first abnormality determining task (see FIG. 4) based on whether the engine stop mode is established.

For example, upon determination that the engine stop mode is established, the first abnormality determiner 34 clears, if it was determined that the pulse pattern of the crank angle signal was abnormal in step S31 before the current execution of the first abnormality determining task illustrated in FIG. 4, the determined result, thus disabling execution of the first abnormality determining task. Otherwise, upon determination that the engine stop mode is not established, the first abnormality determiner 34 executes the first abnormality determining task, i.e. the operations in steps S23 to S31.

In the second embodiment, the second abnormality determiner 35 is configured to determine whether to execute the second abnormality determining task (see FIG. 5) based on whether the engine stop mode is established.

For example, upon determination that the engine stop mode is established, the second abnormality determiner 35 clears, if it was determined that the pulse pattern of the cam angle signal was abnormal in step S61 before the current execution of the second abnormality determining task illustrated in FIG. 5, the determined result, thus disabling execution of the second abnormality determining task. Otherwise, upon determination that the engine stop mode is not established, the second abnormality determiner 35 executes the second abnormality determining task, i.e. the operations in steps S53 to S61.

In the second embodiment, the crank-angle position reviewing module 36 is configured to determine whether to execute the crank-angle position reviewing task (see FIG. 6) based on whether the engine stop mode is established.

For example, upon determination that the engine stop mode is established, the crank-angle position reviewing module 36 clears the value of the reset determination variable CYLNGCNT to zero, which was counted up in step S99 described later before the current execution of the crank-angle position reviewing task illustrated in FIG. 6, thus disabling execution of the crank-angle position reviewing task. Otherwise, upon determination that the engine stop mode is not established, the crank-angle position reviewing module 36 executes the crank-angle position reviewing task, i.e. the operations in steps S83 to S100, and S82.

Operations of the engine control system 1A will be described hereinafter.

The engine control system 1A establishes the engine stop mode when the ignition switch is turned from the on state to the off state (see steps S141 and S142). During the ignition switch is in the off state, the engine control system 1A updates the rotational position of the crankshaft 101 stored in the storage 39 each time a new one is detected by the crank-angle detector 33 (see steps S143 and S144). Thereafter, when rotation of the crankshaft 101 is completely stopped, the engine control system 1A stores the crank angle position detected by the crank-angle detector 33 at the timing when rotation of the crankshaft 101 is completely stopped (see steps S145 and S146).

When the ignition switch is turned from the off state to the on state, the engine control system 1A sets the crank angle position stored in the storage 39, i.e. the crank angle position detected by the crank-angle detector 33 at the timing when rotation of the crankshaft 101 is completely stopped, as a crank angle position used for cylinder identification at the restart of the engine (see steps S147 and S148). Thereafter, when the starter signal is turned from the off state to the on state, the engine control system 1A eliminates the established engine stop mode (see steps S147 to 150), and identifies a cylinder in which combustion of air-fuel mixture will take place at the restart of the engine using the set crank angle position stored in the storage 39.

As described above, the engine control system 1A determines that the engine stop mode is established during the period from the turn-off of the ignition switch to the timing when the starter signal is turned on, and that the engine stop mode is not established when the starter signal is turned on.

In addition, the engine control system 1A according to the second embodiment is configured to determine whether to execute each of the first abnormality determining task, the second abnormality determining task, and the crank-angle position reviewing task based on whether the engine stop mode is established in comparison to whether the idle-reduction mode is established according to the first embodiment.

Specifically, the engine control system 1A disables execution of the first abnormality determining task, the second abnormality determining task, and the crank-angle position reviewing task if the engine control system 1A may erroneously detect tooth-missing regions due to reverse rotation of the crankshaft 101. This makes it possible to prevent the engine control system 1A from mistakenly determining that the pulse pattern of the crank angle signal or that of the cam angle signal is abnormal, and prevent the engine control system 1A from mistakenly reviewing the identified position of each cylinder.

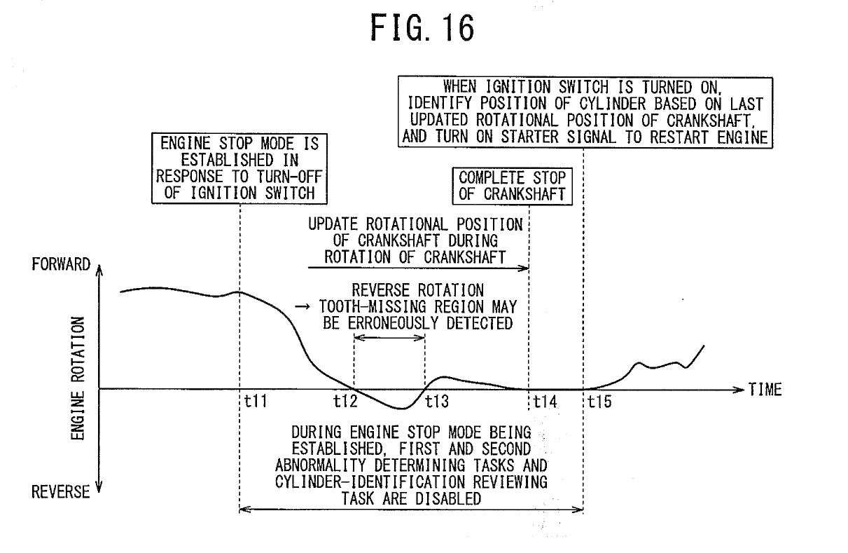

Next, an example of sequential operations of the engine control system 1A will be described hereinafter with reference to FIG. 16.

At time t11, the engine control system 1A performs control for stopping the engine when the ignition switch is turned off, and establishes the engine stop mode. When the engine stop mode is established, the engine control system 1A disables execution of the first abnormality determining task, the second abnormality determining task, and the crank-angle position reviewing task for the period from the time t11 to time t15 during which the engine stop mode is established until turn-on of the ignition switch.

Specifically, the engine control system 1A disables execution of the first abnormality determining task, the second abnormality determining task, and the crank-angle position reviewing task for the period from time t12 to time t13 during which the engine control system 1A may erroneously detect tooth-missing regions due to reverse rotation of the crankshaft 101. This makes it possible to prevent the engine control system 1A from mistakenly determining that the pulse pattern of the crank angle signal or that of the cam angle signal is abnormal, and prevent the engine control system 1A from mistakenly reviewing the identified position of each cylinder.

In addition, even if the engine stop mode is established, the engine control system 1A updates the rotational position of the crankshaft 101 stored in the storage 39 each time a new one is detected by the crank-angle detector 33 until rotation of the crankshaft 101 is completely stopped (see the period up to time t14). When rotation of the crankshaft 101 is completely stopped, the engine control system 1A identifies the position of a corresponding cylinder based on the last updated rotational position of the crankshaft 101 stored in the storage 39 at the complete stop of the crankshaft 101, thus turning the starter signal from the off state to the on state to restart the engine at the time t15.

Particularly, in the second embodiment, the engine operating-condition controller 40, and the operation in step S21, the operation in step S31, and the operation in step S81 serve as, for example, a reverse rotation predicting module configured to predict whether rotation of the crankshaft 101 in the predetermined direction will be reversed.

The engine operating-condition controller 40 serves as, for example, an engine start detector. The engine operating-condition controller 40 and the negative determinations in step S21, S31, and S81 serve as an enabling module configured to enable the reference portion detector to perform the reference portion detecting task if the engine start detector is configured to detect that the engine is started. The crank-angle detector 33 and the operation in step S144 carried out by the engine operating-condition controller 40 serve as, for example, a rotational position updating module configured to update a rotational position of the crankshaft 101 based on the signal output from the signal output module.

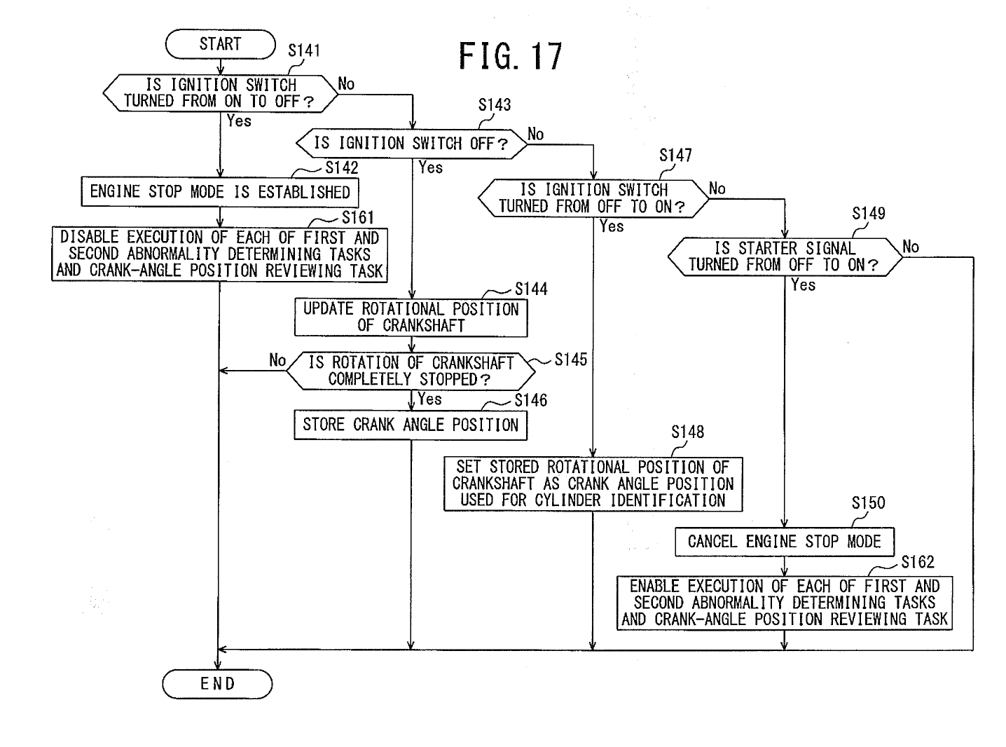

The engine stop-mode determining task is not limited to that illustrated in FIG. 15. Specifically, another example of the engine stop-mode determining task is illustrated in FIG. 17 as a modification of the second embodiment.

As illustrated in FIG. 17, the engine operating-condition controller 40 performs the operation in step S161 after the operation in step S142, and performs the operation in step S162 after the operation in step S150.

In step S161, the engine operating-condition controller 40 disables execution of each of the first and second abnormality determining tasks, and execution of the crank-angle position reviewing task. In step S162, the engine operating-condition controller 40 enables execution of each of the first and second abnormality determining tasks, and execution of the crank-angle position reviewing task. Thus, in the modification, the engine control system 1A performs the determination of whether to disable execution of each of the first abnormality determining task, the second abnormality determining task, and the crank-angle position reviewing task, which are performed in the operations S21, S51, and S81, based on the operations in steps S161 and S162. The first abnormality determining task described in each of steps S161 and S162 corresponds to the operations in steps S23 to S31 illustrated in FIG. 4, and the second abnormality determining task described in each of steps S161 and S162 corresponds to the operations in steps S53 to S61 illustrated in FIG. 5. The crank-angle position reviewing task described in each of steps S161 and S162 corresponds to the operations in steps S83 to S100 and S82 illustrated in FIG. 6.

The modifications of the first embodiment can be applied to the second embodiment as long as they are applicable thereto.

In the first embodiment, the rotational position of the crankshaft 101 is updated during execution of the idle-reduction mode determining task, and in the second embodiment, the rotational position of the crankshaft 101 is updated during execution of the engine stop-mode determining task.

However, the first embodiment is not limited to the updating method set forth above, and the second embodiment is not limited to the updating method set forth above.

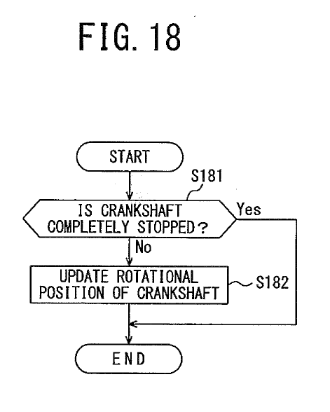

FIG. 18 schematically illustrates another example of a task to update the rotational position of the crankshaft 101.

Referring to FIG. 18, the ECU 30 or 30A, such as the crank-angle detector 33, determines whether rotation of the crankshaft 101 is completely stopped in step S181. Upon determination that rotation of the crankshaft 101 is completely stopped, the ECU 30 or 30A terminates the task illustrated in FIG. 18. Otherwise, upon determination that rotation of the crankshaft 101 is not completely stopped, the ECU 30 or 30A performs the operation in step S182.

In step S182, the ECU 30 or 30A updates the rotational position of the crankshaft 101 stored in the storage 39 each time a new one is detected by the crank-angle detector 33 until rotation of the crankshaft 101 is completely stopped. The crank-angle position reviewing module 36 can be configured to perform the crank-angle position reviewing task using the updated rotational positions of the crankshaft 101.

In each of the first and second embodiments, a corresponding engine control system is configured to predict reverse rotation of the crankshaft 101 based on start of the idle-reduction task or the control task for stopping the engine, i.e. output of the engine stop instruction to the fuel-ignition controller 37 (see step S21, S51, S81, or S141). However, a corresponding engine control system according to each of the first and second embodiments is not limited to the configuration. Specifically, a corresponding engine control system according to each of the first and second embodiments can be configured to predict reverse rotation of the crankshaft 101 based on measured values of a sensor installed in the vehicle, such as measured pulses of the crank angle sensor 2.

While illustrative embodiments of the present invention have been described herein, the present invention is not limited to the embodiments described herein, but includes any and all embodiments having modifications, omissions, combinations (e.g., of aspects across various embodiments), adaptations and/or alternations as would be appreciated by those in the art based on the present invention. The limitations in the claims are to be interpreted broadly based on the language employed in the claims and not limited to examples described in the present specification or during the prosecution of the application, which examples are to be construed as non-exclusive.

What is claimed is:

1. A system for controlling an engine having at least one cylinder and a crankshaft, the system comprising:
a signal output module configured to produce pulses based on rotation of the crankshaft, and output a signal having the pulses, a pattern of the pulses showing at least one reference portion of the crankshaft to which a position of the at least one cylinder is relative;
a reference portion detector configured to perform a reference portion detecting task that detects, based on the pattern of the pulses of the signal during rotation of the crankshaft in a predetermined direction, the at least one reference portion of the crankshaft;
a reverse rotation predicting module configured to predict whether rotation of the crankshaft in the predetermined direction will be reversed; and
a disabling module configured to disable the reference portion detector from performing the reference portion detecting task if the reverse rotation predicting module predicts that rotation of the crankshaft in the predetermined direction will be reversed.

2. The system according to claim 1, further comprising:
an abnormality determiner configured to perform an abnormality determining task that determines whether there is an abnormality in the pattern of the pulses of the signal based on the at least one reference portion of the crankshaft,
wherein the disabling module is configured to disable the abnormality determiner from performing the abnormality determining task if the reverse rotation predicting module predicts that rotation of the crankshaft in the predetermined direction will be reversed.

3. The system according to claim 1, wherein the reverse rotation predicting module is configured to predict that rotation of the crankshaft in the predetermined direction will be reversed during a period from an occurrence of a request to stop the engine to complete stop of rotation of the crankshaft of the engine.

4. The system according to claim 1, further comprising:
an engine start detector configured to detect that the engine is started; and
an enabling module configured to enable the reference portion detector to perform the reference portion detecting task if the engine start detector is configured to detect that the engine is started.

5. The system according to claim 2, further comprising:
an engine start detector configured to detect that the engine is started; and
an enabling module configured to enable the abnormality determiner to perform the abnormality determining task if the engine start detector is configured to detect that the engine is started.

6. The system according to claim 3, wherein the request to stop the engine is one of a request to start idle reduction of the engine and a request to stop the engine in response to turn-off of an ignition switch.

7. The system according to claim 1, wherein the position of the at least one cylinder is changed based on rotation of the crankshaft, the system further comprising:
a cylinder-position identifying module configured to perform a cylinder-position identifying task that identifies the position of the at least one cylinder based on the signal output from the signal output module,
the disabling module being configured to disable the cylinder-position identifying module to perform the cylinder-position identifying task if the reverse rotation predicting module predicts that rotation of the crankshaft in the predetermined direction will be reversed.

8. The system according to claim 7, wherein the reverse rotation predicting module is configured to predict that rotation of the crankshaft in the predetermined direction will be reversed during a period from an occurrence of a request to stop the engine to complete stop of rotation of the crankshaft of the engine, the system further comprising:
an engine start detector configured to detect that the engine is started; and
an enabling module configured to enable the cylinder-position identifying module to perform the cylinder-position identifying task if the engine start detector is configured to detect that the engine is started.

9. The system according to claim 8, further comprising:
a rotational position updating module configured to update a rotational position of the crankshaft based on the signal output from the signal output module,
wherein the cylinder-position identifying module is configured to identify, in the cylinder-position identifying task enabled by the enabling module, the position of the at least one cylinder based on the rotational position of the crankshaft last updated by the rotational position updating module while the reverse rotation predicting module predicts that rotation of the crankshaft in the predetermined direction will be reversed.

10. The system according to claim 1, wherein the engine has a camshaft that rotates based on rotation of the crankshaft, the system further comprising:
a cam-signal output module configured to produce pulses based on rotation of the camshaft, and output a cam-signal having the pulses; and
an abnormality determiner configured to perform an abnormality determining task that determines whether there is an abnormality in a pattern of the pulses of the cam-signal based on the reference portion of the crankshaft,
the disabling module being configured to disable the abnormality determiner from performing the abnormality determining task if the reverse rotation predicting module predicts that rotation of the crankshaft in the predetermined direction will be reversed.

11. The system according to claim 10, wherein the reverse rotation predicting module is configured to predict that rotation of the crankshaft in the predetermined direction will be reversed during a period from an occurrence of a request to stop the engine to complete stop of rotation of the crankshaft of the engine, the system further comprising:
an engine start detector configured to detect that the engine is started; and
an enabling module configured to enable the abnormality determiner to perform the abnormality determining task if the engine start detector is configured to detect that the engine is started.

12. The system according to claim 1, wherein the signal output module comprises an encoder member comprising:
a reluctor disc mounted coaxially on the crankshaft;
a signal generator portion having a number of equidistant teeth distributed around a periphery of the reluctor disc; and
first and second tooth-missing portions each being a predetermined region on the periphery of the reluctor disc in which a predetermined number of teeth are missed, the first and second tooth-missing portions serving as the at least one reference portion of the crankshaft,
the signal output module being configure to produce a pulse of the signal each time a tooth of the signal generator portion passes through a predetermined position with a given angle of rotation of the crankshaft,
each of the first and second tooth-missing portions causing an irregular pulse interval in the signal,
the reference portion detector being configured to perform the reference portion detecting task that detects, based on the irregular pulse intervals in the signal while the rotational direction of the crankshaft is the predetermined direction, the respective first and second tooth-missing portions.
